(19) United States
(12) Patent Application Publication
(10) Pub. No.: US 2014/0016049 A1
(43) Pub. Date: Jan. 16, 2014

(54) DISPLAY UNIT AND ELECTRONIC APPARATUS

(71) Applicant: Sony Corporation, Tokyo (JP)

(72) Inventors: Akira Yoshikaie, Tokyo (JP); Yuichi Inoue, Kanagawa (JP); Sho Sakamoto, Tokyo (JP); Kenichi Takahashi, Kanagawa (JP)

(73) Assignee: Sony Corporation, Tokyo (JP)

(21) Appl. No.: 13/928,935

(22) Filed: Jun. 27, 2013

(30) Foreign Application Priority Data
Jul. 10, 2012 (JP) 2012-154365

(51) Int. Cl. G02F 1/13

(52) U.S. Cl. CPC G02F 1/1313
USPC 349/15

(57) ABSTRACT

A display unit includes: a light-ray control section including first structures, the first structures being arranged at a first pitch; a liquid crystal display section including second structures, the second structures being arranged at a second pitch; and a backlight, in which one in which a structure arrangement pitch is smaller of the liquid crystal display section and the light-ray control section is disposed between the other one of the liquid crystal display section and the light-ray control section, and the backlight.

### BACKGROUND

The present disclosure relates to a display unit enabling stereoscopic display, and an electronic apparatus including such a display unit.

In recent years, display units enabling stereoscopic display have been attracting attention. In stereoscopic display, a left-eye image and a right-eye image having parallax therebetween (having different perspectives) are displayed, and when a viewer sees the left-eye image and the right-eye image with his left eye and his right eyes, respectively, the viewer perceives the images as a stereoscopic image with depth. Moreover, display units capable of providing a more natural stereoscopic image to a viewer through displaying three or more images having parallax therebetween have been also developed.

Such display units are broadly classified into display units which use special glasses and display units which use no special glasses. Viewers find wearing the special glasses inconvenient; therefore, the display units which use no special glasses are desired. Examples of the display units which use no special glasses include a parallax barrier type and a lenticular lens type. In these types, a plurality of images (perspective images) having parallax therebetween are displayed together, and a viewer sees images different depending on a relative positional relationship (angle) between a display unit and the viewer. For example, in Japanese Unexamined Patent Application Publication No. H03-119889, a parallax barrier type display unit using a liquid crystal device as a barrier is disclosed.

### SUMMARY

In general, high image quality is desired in display units, and display units enabling stereoscopic display are also expected to achieve high image quality.

It is desirable to provide a display unit and an electronic apparatus which are capable of enhancing image quality.

According to an embodiment of the disclosure, there is provided a display unit including: a light-ray control section including first structures, the first structures being arranged at a first pitch; a liquid crystal display section including second structures, the second structures being arranged at a second pitch; and a backlight, in which one in which a structure arrangement pitch is smaller of the liquid crystal display section and the light-ray control section is disposed between the other one of the liquid crystal display section and the light-ray control section, and the backlight.

According to an embodiment of the disclosure, there is provided an electronic apparatus provided with a display unit and a control section which performs operation control with use of the display unit, the display unit including: a light-ray control section including first structures, the first structures being arranged at a first pitch; a liquid crystal display section including second structures, the second structures being arranged at a second pitch; and a backlight, in which one in which a structure arrangement pitch is smaller of the liquid crystal display section and the light-ray control section is disposed between the other one of the liquid crystal display section and the light-ray control section, and the backlight. The electronic apparatus according to the embodiment of the disclosure may include, for example, a television, a digital camera, a personal computer, a video camera, or a portable terminal device such as a cellular phone.

In the display unit and the electronic apparatus according to the embodiments of the disclosure, light emitted from the backlight exits through the light-ray control section and the liquid crystal display section to be seen by a viewer. One in which the structure arrangement pitch is larger of the liquid crystal display section and the light-ray control section is disposed closer to the viewer, and the other one in which the structure arrangement pitch is smaller of the liquid crystal display section and the light-ray control section is disposed closer to the backlight.

In the display unit and the electronic apparatus according to the embodiments of the disclosure, one in which the structure arrangement pitch is smaller of the liquid crystal display section and the light-ray control section is disposed between the other one of the light crystal display section and the light-ray control section, and the backlight; therefore, image quality is allowed to be enhanced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a block diagram illustrating a configuration example of a stereoscopic display unit according to an embodiment of the disclosure.

FIGS. 2A and 2B are explanatory diagrams illustrating a configuration example of the stereoscopic display unit illustrated in FIG. 1.

FIG. 3 is a block diagram illustrating a configuration example of a display drive section illustrated in FIG. 1.

FIG. 4 is an explanatory diagram illustrating a configuration example of a display section illustrated in FIG. 1.

FIG. 5 is a circuit diagram illustrating a configuration example of a sub-pixel illustrated in FIG. 4.

FIG. 6 is a sectional view illustrating a configuration example of the display section illustrated in FIG. 1.

FIGS. 7A and 7B are explanatory diagrams illustrating a configuration example of the sub-pixel illustrated in FIG. 4.

FIGS. 8A to 8C are explanatory diagrams illustrating operation examples of the sub-pixel illustrated in FIGS. 7A and 7B.

FIG. 9 is an explanatory diagram illustrating a configuration example of a barrier section illustrated in FIG. 1.

FIG. 10 is a sectional view illustrating a configuration example of a barrier section according to a first embodiment.

FIGS. 11A and 11B are explanatory diagrams illustrating a configuration example of the barrier section according to the first embodiment.

FIG. 12 is an explanatory diagram illustrating a group configuration example of opening-closing sections illustrated in FIG. 9.

FIGS. 13A to 13D are schematic views illustrating a relationship between the display section and the barrier section illustrated in FIG. 1.

FIG. 14 is a schematic view illustrating an operation example of the stereoscopic display unit illustrated in FIG. 1.

FIG. 15 is an explanatory diagram illustrating scattering of light in the stereoscopic display unit illustrated in FIG. 1.

FIG. 16 is an explanatory diagram for describing crosstalk in the stereoscopic display unit illustrated in FIG. 1.

FIG. 17 is a plot illustrating crosstalk characteristics in stereoscopic display units.

FIGS. 18A and 18B are explanatory diagrams illustrating a configuration example of a stereoscopic display unit according to an arrangement A2.

FIGS. 19A and 19B are explanatory diagrams illustrating a configuration example of a barrier section according to an electrode shape B1.

FIGS. 20A and 20B are plots illustrating characteristic examples of barrier sections according to electrode shapes B2 and B3.

FIG. 21 is a plot illustrating moire characteristics in stereoscopic display units.

FIG. 22 is an explanatory diagram illustrating a characteristic example of the barrier section according to the electrode shape B2.

FIG. 23 is an explanatory diagram illustrating a characteristic example of the barrier section according to the electrode shape B1.

FIG. 24 is an explanatory diagram illustrating a configuration example of a display section according to a modification of the first embodiment.

FIG. 25 is an explanatory diagram illustrating a configuration example of a sub-pixel illustrated in FIG. 24.

FIGS. 26A to 26C are explanatory diagrams illustrating a configuration example of a sub-pixel according to another modification of the first embodiment.

FIGS. 27A to 27C are explanatory diagrams illustrating a configuration example of a sub-pixel according to still another modification of the first embodiment.

FIG. 28 is a sectional view illustrating a configuration example of a display section according to a further modification of the first embodiment.

FIGS. 29A and 29B are explanatory diagrams illustrating a configuration example of a sub-pixel illustrated in FIG. 28.

FIGS. 30A and 30B are explanatory diagrams illustrating operation examples of the sub-pixel illustrated in FIG. 28.

FIG. 31 is a sectional view illustrating a configuration example of a barrier section according to a second embodiment.

FIG. 32 is an explanatory diagram illustrating a configuration example of the barrier section illustrated in FIG. 31.

FIG. 33 is an explanatory diagram illustrating a configuration example of a barrier section according to a modification of the second embodiment.

FIG. 34 is a sectional view illustrating a configuration example of a display section according to another modification of the second embodiment.

FIGS. 35A to 35C are explanatory diagrams illustrating a configuration example of a sub-pixel illustrate din FIG. 34.

FIG. 36 is a perspective view illustrating an appearance of a television to which any one of the stereoscopic display units according to the embodiments is applied.

### DETAILED DESCRIPTION

Some embodiments of the present disclosure will be described in detail below referring to the accompanying drawings. It is to be noted that description will be given in the following order.

1. First Embodiment

2. Second Embodiment

3. Application Examples

### 1. FIRST EMBODIMENT

### [Configuration Example]

### (Entire Configuration Example)

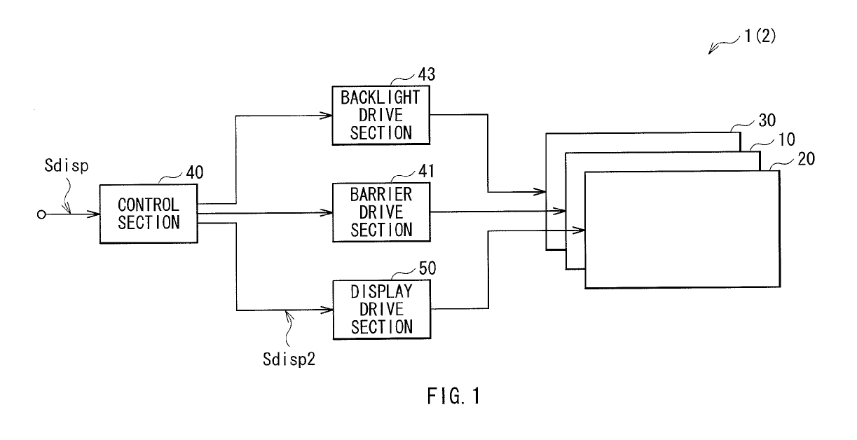

FIG. 1 illustrates a configuration example of a stereoscopic display unit 1 according to a first embodiment. The stereoscopic display unit 1 is a parallax barrier type display unit using a liquid crystal barrier. The stereoscopic display unit 1 includes a control section 40, a backlight drive section 43, a backlight 30, a barrier drive section 41, a barrier section 10, a display drive section 50, and a display section 20.

The control section 40 is a circuit which supplies a control signal to each of the backlight drive section 43, the barrier drive section 41, and the display drive section 50, based on an image signal Sdisp externally supplied thereto, and thereby controls these sections to operate in synchronization with one another. More specifically, the control section 40 supplies a backlight control signal, a barrier control signal, and an image signal Sdisp2 which is generated based on the image signal Sdisp to the backlight drive section 43, the barrier drive section 41, and the display drive section 50, respectively. In this case, the image signal Sdisp2 is an image signal S2D including one perspective image when the stereoscopic display unit 1 performs normal display (two-dimensional display), and is an image signal S3D including a plurality of (eight in this example) perspective images when the stereoscopic display unit 1 performs stereoscopic display, as will be described later.

The backlight drive section 43 drives the backlight 30 based on the backlight control signal supplied from the control section 40. The backlight 30 has a function of emitting light toward the barrier section 10 and the display section 20 by surface emission. The backlight 30 may be configured of, for example, LEDs (Light Emitting Diodes) or CCFLs (Cold Cathode Fluorescent Lamps).

The barrier drive section 41 drives the barrier section 10 based on the barrier control signal supplied from the control section 40. The barrier section 10 allows light incident thereon to pass therethrough (an open operation) or blocks the light incident thereon (a close operation), and the barrier section 10 includes a plurality of opening-closing sections 11 and 12 (which will be described later) formed with use of a liquid crystal.

The display drive section 50 drives the display section 20 based on the image signal Sdisp2 supplied from the control section 40. In this example, the display section 20 is a liquid crystal display section, and drives liquid crystal display elements to modulate light incident thereon, and thereby performs display.

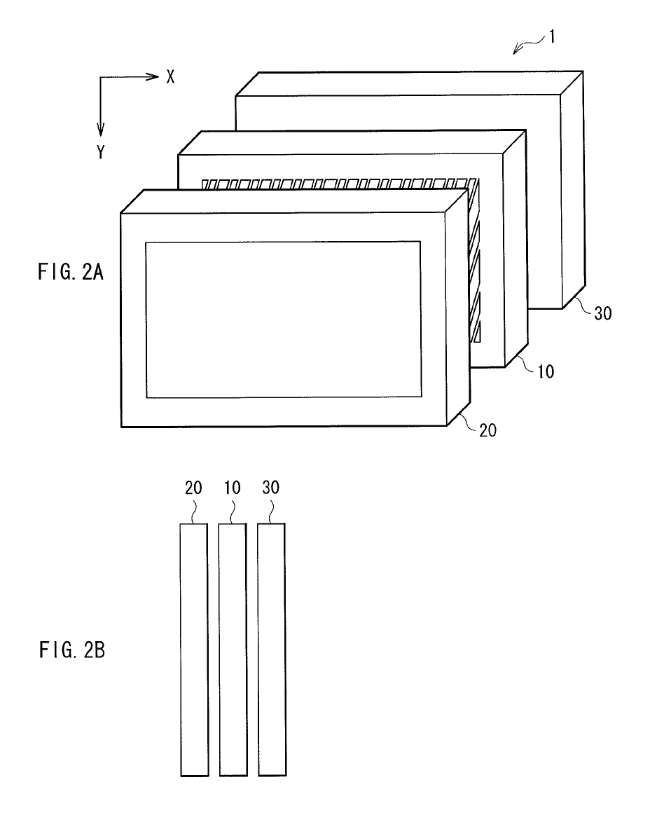

FIGS. 2A and 2B illustrate a configuration example of a main part of the stereoscopic display unit 1. FIG. 2A illustrates an exploded perspective configuration of the stereoscopic display unit 1, and FIG. 2B illustrates a side view of the stereoscopic display unit 1. As illustrated in FIGS. 2A and 2B, in the stereoscopic display unit 1, the backlight 30, the barrier section 10, and the display section 20 are arranged in this order. In other words, light which has been emitted from the backlight 30 and has passed through the barrier section 10 is modulated by the display section 20, and then the light reaches a viewer.

### (Display Drive Section 50 and Display Section 20)

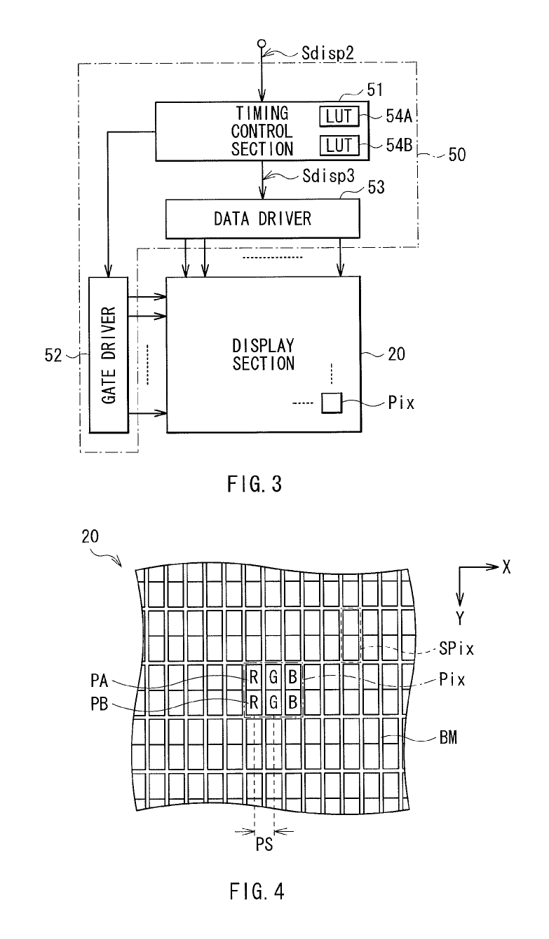

FIG. 3 illustrates an example of a block diagram of the display drive section 50. The display drive section 50 includes a timing control section 51, a gate driver 52, and a data driver 53. The timing control section 51 controls drive timings of the gate driver 52 and the data driver 53, and generates an image signal Sdisp3 based on the image signal Sdisp2 supplied from the control section 40, and then supplies the image signal Sdisp3 to the data driver 53. The gate driver 52 sequentially selects pixels Pix in the display section 20 from one row to another in response to timing control by the timing control section 51 to line-sequentially scan the pixels Pix. The data driver 53 supplies a pixel signal based on the image signal Sdisp3 to each of the pixels Pix in the display section 20. More specifically, the data driver 53 performs D/A (digital-to-analog) conversion based on the image signal Sdisp3 to generate a pixel signal which is an analog signal, and then supplies the pixel signal to each of the pixels Pix.

The timing control section 51 has LUTs (Look Up Tables) 54A and 54B. The LUTs 54A and 54B are tables for performing so-called gamma correction on pixel information (luminance information) for each of the pixels Pix included in the image signal Sdisp2. The LUT 54A is a table for a sub-pixel portion PA (which will be described later) of a sub-pixel SPix, and the LUT 54B is a table for a sub-pixel portion PB (which will be described later) of the sub-pixel SPix. The timing control section 51 performs, on the pixel information (the luminance information), different gamma corrections with use of the LUTs 54A and 54B to generate the image signal Sdisp3. The data driver 53 supplies a pixel signal generated with use of the LUT 54A to the sub-pixel portion PA (which will be described later) of the sub-pixel SPix and supplies a pixel signal generated with use of the LUT 54B to the sub-pixel portion PB (which will be described later) of the sub-pixel SPix. As will be described later, in the display section 20, the sub-pixel portions PA and PB perform display based on the respective pixel signals. In other words, the display section 20 performs display by halftone driving in which the sub-pixel portions PA and PB display one piece of pixel information with difference gamma characteristics.

FIG. 4 illustrates a configuration example of the display section 20. The pixels Pix are arranged in a matrix form in the display section 20. Each of the pixels Pix includes three sub-pixels SPix corresponding to red (R), green (G), and blue (B). The sub-pixels SPix are arranged at a predetermined pitch (a sub-pixel pitch PS) in a horizontal direction. A so-called black matrix BM is formed between the sub-pixels SPix to block light incident thereon. Thus, in the display section 20, mixing of red (R), green (G), and blue (B) is less likely to occur. Each of the sub-pixels SPix includes the sub-pixel portions PA and PB arranged side by side in a vertical direction Y. It is to be noted that, in this example, sizes of the sub-pixel portions PA and PB are equal to each other; however the sizes of the sub-pixel portions PA and PB are not limited thereto, and, for example, the sub-pixel portion PA may be larger in size than the sub-pixel portion PB.

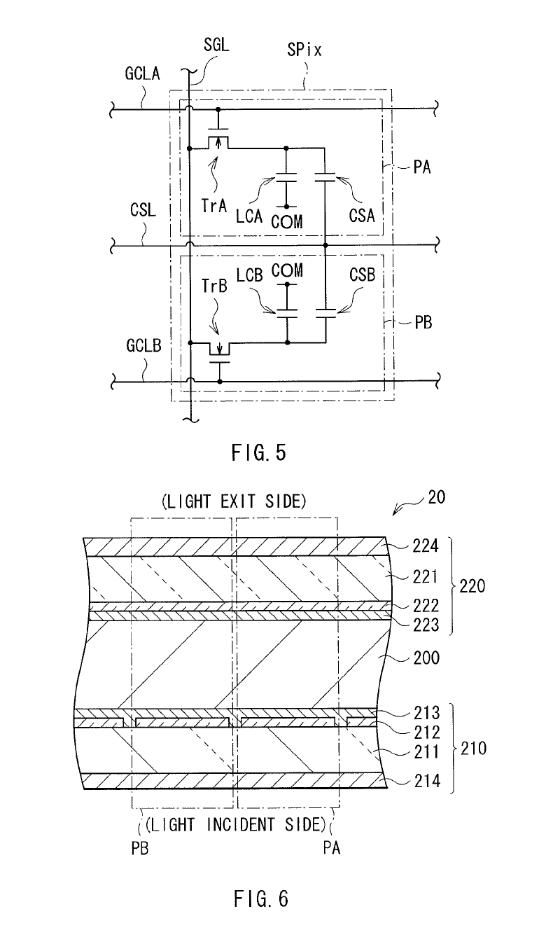

FIG. 5 illustrates an example of a circuit diagram of the sub-pixel SPix. The sub-pixel portion PA of the sub-pixel SPix includes a TFT element TrA configured of, for example, a MOS-FET (Metal Oxide Semiconductor Field Effect Transistor), a liquid crystal element LCA, and a retention capacitor CsA. In the TFT element TrA, a gate thereof is connected to a gate line GCLA, a source thereof is connected to a data line SGL, and a drain thereof is connected to one end of the liquid crystal element LCA and one end of the retention capacitor CsA. In the liquid crystal element LCA, the one end thereof is connected to the drain of the TFT element TrA, and the other end thereof is connected to a common electrode COM (a counter electrode 222 which will be described later) to be grounded. In the retention capacitor CsA, the one end thereof is connected to the drain of the TFT element TrA, and the other end thereof is connected to a retention capacitor line CSL. Likewise, the sub-pixel portion PB of the sub-pixel SPix includes a TFT element TrB configured of, for example, a MOS-FET, a liquid crystal element LCB, and a retention capacitor CsB. In the TFT element TrB, a gate thereof is connected to a gate line GCLB, a source thereof is connected to the data line SGL, and a drain thereof is connected to one end of the liquid crystal element LCB and one end of the retention capacitor CsB. In the liquid crystal element LCB, the one end thereof is connected to the drain of the TFT element TrB, and the other end thereof is connected to the common electrode COM (the counter electrode 222 which will be described later) to be grounded. In the retention capacitor CsB, the one end thereof is connected to the drain of the TFT element TrB, and the other end thereof is connected to the retention capacitor line CSL. The gate lines GCLA and GCLB are connected to the gate driver 52, and the data line SGL is connected to the data driver 53.

FIG. 6 illustrates a sectional configuration example of the display section 20. The display section 20 is configured through sealing a liquid crystal layer 200 between a drive substrate 210 and a counter substrate 220.

The drive substrate 210 includes a transparent substrate 211, pixel electrodes 212, an alignment film 213, and a polarizing plate 214. The transparent substrate 211 may be made of, for example, glass, and the TFT elements TrA and TrB and the like (not illustrated) are formed on a surface of the transparent substrate 211. The pixel electrodes 212 are disposed corresponding to the respective sub-pixel portions PA and PB on the transparent substrate 211. Each of the pixel electrodes 212 may be configured of, for example, a transparent conductive film of ITO (Indium Tin Oxide) or the like, and the pixel electrodes 212 are uniformly formed in respective regions of the sub-pixel portions PA and PB. The alignment film 213 is formed on the pixel electrodes 212. The alignment film 213 is subjected to so-called photo-alignment treatment for determining an alignment direction of liquid crystal molecules M in the liquid crystal layer 200 by, for example, ultraviolet irradiation. The polarizing plate 214 is bonded to a surface of the transparent substrate 211 opposite to a surface where the pixel electrodes 212 and the like are formed of the transparent substrate 211.

The counter substrate 220 includes a transparent substrate 221, a counter electrode 222, an alignment film 223, and a polarizing plate 224. As with the transparent substrate 211, the transparent substrate 221 may be made of, for example, glass, and a color filter or the black matrix BM which are not illustrated are formed on a surface of the transparent substrate 221. The counter electrode 222 is disposed on the transparent substrate 221 as an electrode common to the sub-pixels SPix. The counter electrode 222 may be configured of a transparent conductive film of ITO or the like, and in this example, the counter electrode 222 is uniformly formed throughout the display section 20. The alignment film 223 is formed on the counter electrode 222. As with the alignment film 213, the alignment film 223 is subjected to so-called photo-alignment treatment. The polarizing plate 224 is bonded to a surface of the transparent substrate 221 opposite to a surface where the counter electrode 222 and the like are formed of the transparent substrate 221.

The liquid crystal layer 200 includes, for example, the liquid crystal molecules M with negative dielectric anisotropy. The liquid crystal layer 200 includes liquid crystal molecules M vertically aligned by an alignment film. In other words, the liquid crystal layer 200 functions as a so-called VA (Vertical Alignment) liquid crystal.

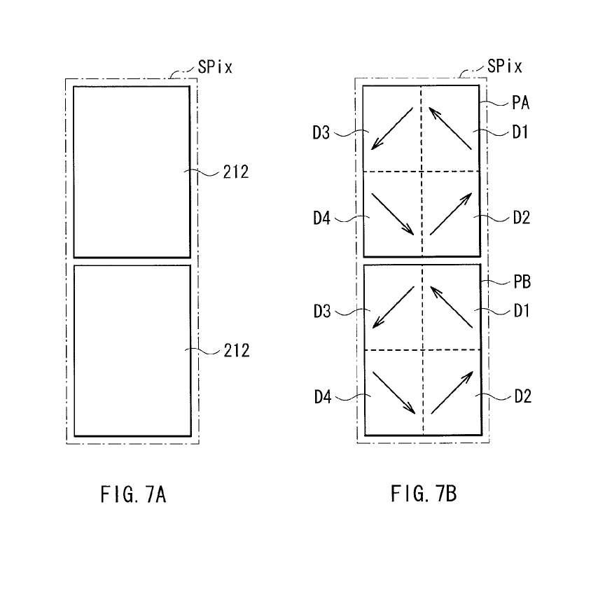

FIGS. 7A and 7B illustrate the sub-pixel SPix, and FIG. 7A illustrates the pixel electrodes 212, and FIG. 7B schematically illustrates average alignment directions of liquid crystal molecules M upon voltage application. As illustrated in FIG. 7A, the pixel electrodes 212 are uniformly formed corresponding to the sub-pixel portions PA and PB. Moreover, in the display section 20, as illustrated in FIG. 7B, each of the sub-pixel portions PA and PB has a plurality of regions (domains D1 to D4) with different alignment directions of the liquid crystal molecules M. These domains D1 to D4 are formed by photo-alignment treatment on the alignment films 213 and 223 so as to have the alignment direction of the liquid crystal molecules M differing between the domains D1 to D4, and the domains D1 to D4 have a substantially equal area.

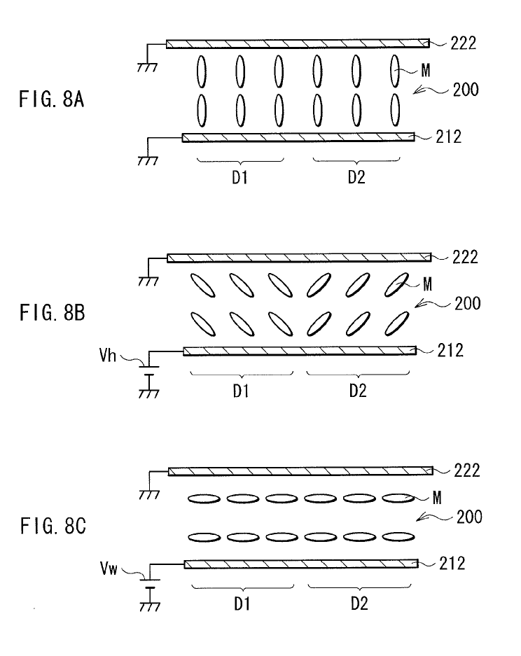

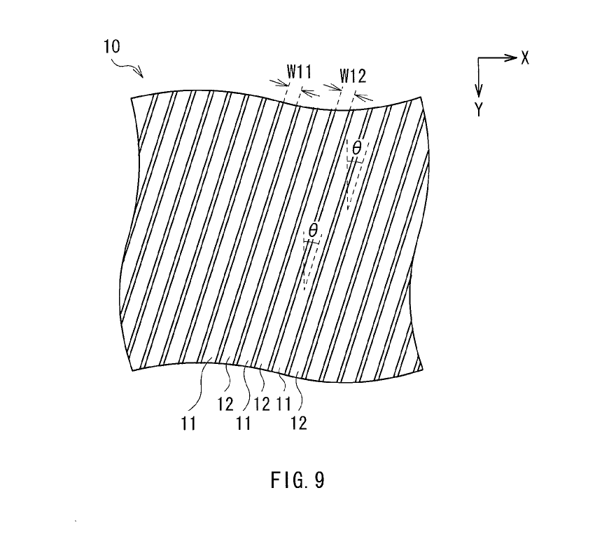

FIGS. 8A to 8C schematically illustrate alignment of the liquid crystal molecules M in two different domains (in this example, the domains D1 and D2). FIGS. 8A illustrates alignment of the liquid crystal molecules M in the case where a pixel signal with 0 V is applied to the pixel electrode 212, FIG. 8B illustrates alignment of the liquid crystal molecules M in the case where a pixel signal with a voltage Vh is applied to the pixel electrode 212, and FIG. 8C illustrates alignment of the liquid crystal molecules M in the case where a pixel signal with a voltage Vw larger than the voltage Vh is applied to the pixel electrode 212. In this case, the voltage Vh is, for example, about 4 V, and the voltage Vw is, for example, about 8 V.

In the case where the pixel signal with 0 V is applied to the pixel electrode 212, as illustrated in FIG. 8A, long axes of the liquid crystal molecules M are aligned in a direction perpendicular to a substrate surface. In this case, in the sub-pixel portions PA and PB, light transmittance becomes sufficiently low, and black display is performed. Moreover, in the case where the pixel signal with the voltage Vw is applied to the pixel electrode 212, as illustrated in FIG. 8C, the long axes of the liquid crystal molecules M are aligned in a direction parallel to the substrate surface. In this case, in the sub-pixel portions PA and PB, light transmittance becomes high, and so-called white display is performed.

On the other hand, in the case where the pixel signal with the voltage Vh is applied to the pixel electrode 212, as illustrated in FIG. 8B, the long axes of the liquid crystal molecules M are tilted toward an intermediate direction between the direction illustrated in FIG. 8A and the direction illustrated in FIG. 8C. At this time, as illustrated in FIG. 8B, the liquid crystal molecules M in the domain D1 on the left in the drawing and the liquid crystal molecules M in the domain D2 on the right in the drawing are tilted at a substantially equal tilt degree (angle) in directions different from each other. In this case, in the sub-pixel portions PA and PB, light transmittance is at a moderate level, and halftone display is performed.

Thus, in the display section 20, when the pixel signal is applied to the pixel electrodes 212, the liquid crystal molecules M in the domains D1 to D4 are aligned in a direction differing between the domains D1 to D4. At this time, the sub-pixel portions PA and PB are driven by different pixel signals generated with use of the LUTs 54A and 54B, respectively, specifically in a halftone state; therefore, for example, the liquid crystal molecules M in the domain D1 of the sub-pixel portion PA and the liquid crystal molecules M in the domain D1 of the sub-pixel portion PB are aligned in directions different from each other. The liquid crystal molecules M in the domains D2 to D4 of the sub-pixel portion PA and the liquid crystal molecules M in the domains D2 to D4 of the sub-pixel portion PB are aligned in a similar manner. Accordingly, in the display section 20, viewing angle characteristics are allowed to be enhanced.

### (Barrier Section 10)

The barrier section 10 is a parallax barrier configured of liquid crystal barriers. The barrier section 10 will be described in detail below.

FIG. 9 illustrates a configuration example of the barrier section 10. The barrier section 10 includes a plurality of opening-closing sections (liquid crystal barriers) 11 and 12 allowing light to pass therethrough or blocking light. The opening-closing sections 11 and 12 are arranged to extend in one direction (in this example, in a direction forming a predetermined angle θ from a vertical direction Y) on an XY plane, and are alternately arranged in a horizontal direction X. In this example, a width W12 of each of the opening-closing sections 12 is substantially equal to the sub-pixel pitch PS in the display section 20. Moreover, in this example, a width W11 of each of the opening-closing sections 11 and the width W12 of each of the opening-closing sections 12 are substantially equal to each other. It is to be noted that a magnitude relation of the widths of the opening-closing sections 11 and 12 are not limited thereto, and the width W11 may be larger than the width W12 (W11>W12) or may be smaller than the width W12 (W11<W12).

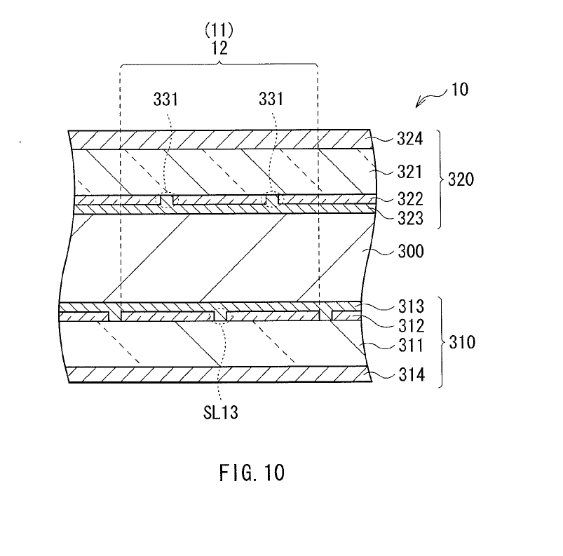

FIG. 10 illustrates a sectional configuration example of the barrier section 10. The barrier section 10 is configured through sealing a liquid crystal layer 300 between a drive substrate 310 and a counter substrate 320.

The drive substrate 310 includes a transparent substrate 311, barrier electrodes 312, an alignment film 313, and a polarizing plate 314. The transparent substrate 311 may be made of, for example, glass. The barrier electrodes 312 are disposed in regions corresponding to the respective opening-closing sections 11 and 12 on the transparent substrate 311. Each of the barrier electrodes 312 may be configured of, for example, a transparent conductive film of ITO (Indium Tin Oxide) or the like, and, as will be described later, each of the barrier electrodes 312 includes a plurality of sub-electrode portions 330 separated by slits SL11 to SL13. The alignment film 313 is formed on the barrier electrode 312. The polarizing plate 314 is bonded to a surface of the drive substrate 311 opposite to a surface where the barrier electrodes 312 and the like are formed of the drive substrate 311.

The counter substrate 320 includes a transparent substrate 321, a counter electrode 322, an alignment film 323, and a polarizing plate 324. As with the transparent substrate 311, the transparent substrate 321 may be made of, for example, glass. The counter electrode 322 is disposed on the transparent substrate 321 as an electrode common to the opening-closing sections 11 and 12, and, as will be described later, holes 331 are formed in the counter electrode 322. The counter electrode 322 may be configured of, for example, a transparent conductive film of ITO or the like. The alignment film 323 is formed on the counter electrode 322. The polarizing plate 324 is bonded to a surface of the transparent substrate 321 opposite to a surface where the counter electrode 322 and the like are formed of the transparent substrate 321.

The liquid crystal layer 300 functions as a so-called VA (Vertical Alignment) liquid crystal, as with the liquid crystal layer 200 in the display section 20.

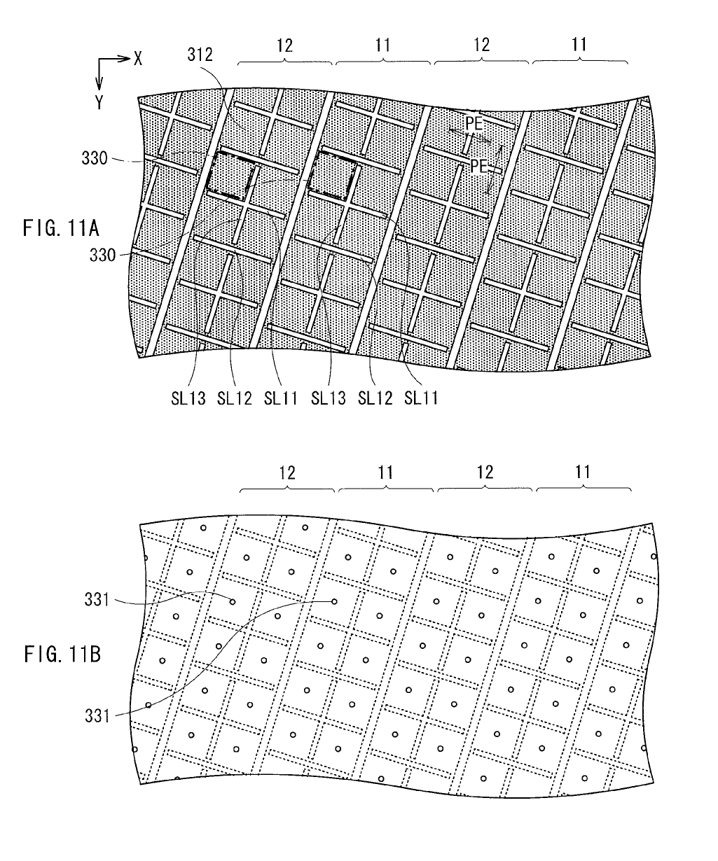

FIGS. 11A and 11B illustrate configuration examples of electrode patterns of the barrier electrode 312 and the counter electrode 322 in the barrier section 10, respectively.

As illustrated in FIG. 11A, the barrier electrodes 312 are formed in portions corresponding to the opening-closing sections 11 and 12, and extend in a direction forming a predetermined angle θ from the vertical direction Y. Each of the barrier electrodes 312 is configured of a plurality of sub-electrode portions 330 arranged side by side at a sub-electrode pitch PE. In other words, the sub-electrode portions 330 are arranged at a pitch (the sub-electrode pitch PE) smaller than the sub-pixel pitch PS in the display section 20, since, as described above, the width W12 of each of the opening-closing sections 12 are substantially equal to the sub-pixel pitch PS in the display section 20. The sub-electrode portions 330 are formed through separating each of the barrier electrodes 312 by the slits SL11 to SL13 formed in each of the barrier electrodes 312. The slits SL11 and SL12 extend in a direction intersecting with an extending direction of the barrier electrodes 312, and are alternately formed in the extending direction of the barrier electrodes 312. The slits SL13 are so formed as to extend in the extending direction of the barrier electrodes 312, and as to intersect with the slits SL11.

As illustrated in FIG. 11B, the counter electrode 322 is formed throughout the barrier section 10. Moreover, each of the holes 331 is formed, in the counter electrode 322, at a position corresponding to around a center of each of the sub-electrode portions 330 in the barrier electrodes 312.

In such a configuration, in the liquid crystal layer 300, light transmittance is varied according to a potential difference between the barrier electrode 312 and the counter electrode 322. Therefore, when a voltage is applied to each of the barrier electrodes 312, the opening-closing sections 11 and 12 each perform an open operation and a close operation.

These opening-closing sections 11 and 12 perform different operations depending on whether the stereoscopic display unit 1 performs normal display (two-dimensional display) or stereoscopic display. In other words, as will be described later, the opening-closing sections 11 are turned into an open state (a transmission state) when normal display is performed, and are turned into a close state (a blocking state) when stereoscopic display is performed. On the other hand, as will be described later, the opening-closing sections 12 are turned into an open state (a transmission state) when normal display is performed, and are turned into an open state (a transmission state) in a time-divisional manner when stereoscopic display is performed. More specifically, the opening-closing sections 12 are divided into a plurality of groups, and when stereoscopic display is performed, a plurality of opening-closing sections 12 belonging to a same group perform an open operation and a close operation at same timing. Groups of the opening-closing sections 12 will be described below.

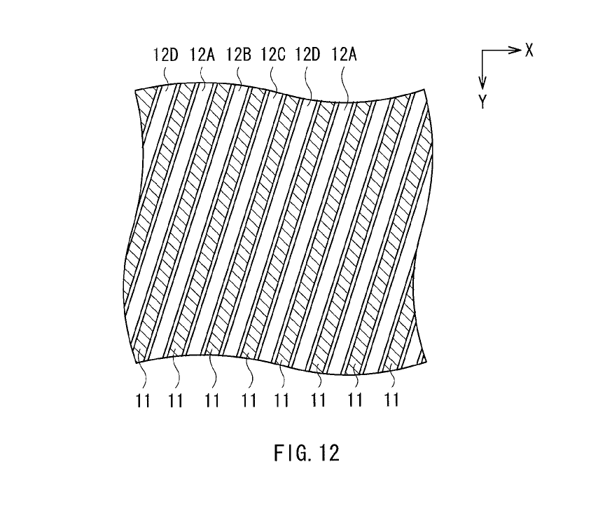

FIG. 12 illustrates a group configuration example of the opening-closing sections 12. In this example, the opening-closing sections 12 are divided into four groups A to D. More specifically, as illustrated in FIG. 12, the opening-closing sections 12 (opening-closing sections 12A) belonging to the group A, the opening-closing sections 12 (opening-closing sections 12B) belonging to the group B, the opening-closing sections 12 (opening-closing sections 12C) belonging to the group C, and the opening-closing section 12 (opening-closing sections 12D) belonging to the group D are alternately arranged in this order.

The barrier drive section 41 drives a plurality of opening-closing sections 12 belonging to a same group to perform the open operation and the close operation at same timing when stereoscopic display is performed. More specifically, as will be described later, a plurality of opening-closing sections 12A belonging to the group A perform an open-and-close operation together, and then, a plurality of opening-closing sections 12B belonging to the group B perform an open-and-close operation together. Next, a plurality of opening-closing sections 12C belonging to the group C perform an open-and-close operation together, and then, a plurality of opening-closing sections 12D belonging to the group D perform an open-and-close operation together. Thus, the barrier drive section 41 alternately drives the opening-closing sections 12A to 12D to perform the open operation and close operation in a time-divisional manner.

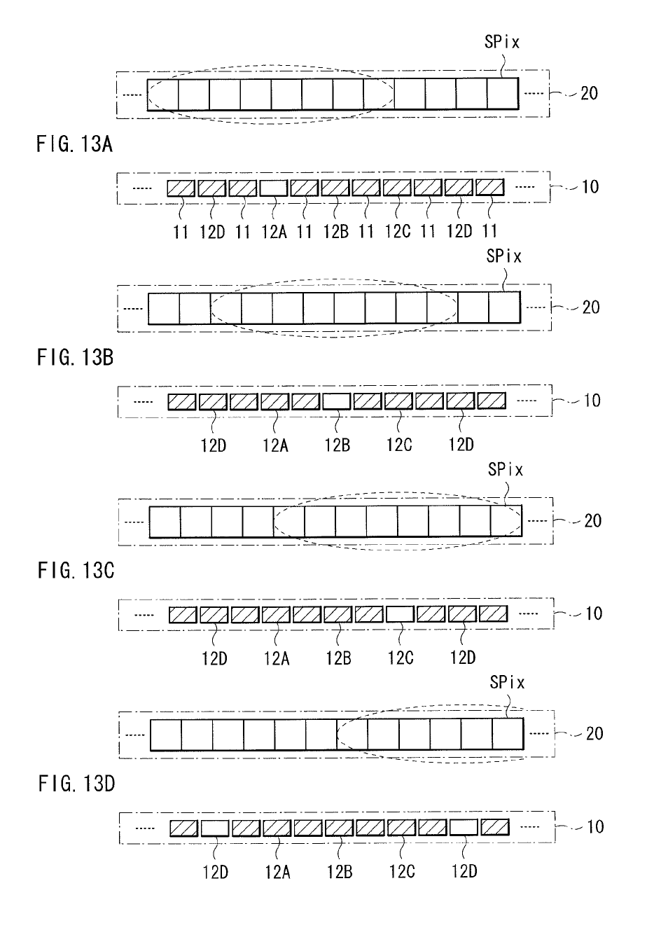

FIGS. 13A to 13D schematically illustrate, with use of sectional configurations, states of the barrier section 10 when stereoscopic display is performed. In this example, one opening-closing section 12A is assigned to eight sub-pixels SPix of the display section 20. Likewise, one opening-closing section 12B is assigned to eight sub-pixels SPix, one opening-closing section 12C is assigned to eight sub-pixels SPix, and one opening-closing section 12D is assigned to eight sub-pixels SPix. It is to be noted that the embodiment of the present disclosure is not limited thereto, and each one of the opening-closing sections 12A, 12B, 12C, and 12D may be assigned to eight pixels Pix instead of eight sub-pixels SPix in the display section 20. In FIGS. 13A to 13D, opening-closing sections blocking light in the opening-closing sections 11 and 12 (12A to 12D) of the barrier section 10 are shaded.

When the stereoscopic display unit 1 performs stereoscopic display, the image signal S3D is supplied to the display drive section 50, and the display section 20 performs display based on the image signal S3D. Then, in the barrier section 10, the opening-closing sections 11 are kept in the close state (the blocking state), and the opening-closing sections 12 (the opening-closing sections 12A to 12D) perform the open operation and the close operation in a time-divisional manner in synchronization with display by the display section 20.

More specifically, in the case where the barrier drive section 41 turns the opening-closing sections 12A into the open state (the transmission state), as illustrated in FIG. 13A, in the display section 20, eight adjacent sub-pixels SPix to which each of the opening-closing sections 12A is assigned display pieces of pixel information P1 to P8 corresponding to eight perspective images. Likewise, in the case where the barrier drive section 41 turns the opening-closing sections 12B into the open state (the transmission state), as illustrated in FIG. 13B, in the display section 20, eight adjacent sub-pixels SPix to which each of the opening-closing sections 12B is assigned display pieces of pixel information P1 to P8 corresponding to eight perspective images. Moreover, in the case where the barrier drive section 41 turns the opening-closing sections 12C into the open state (the transmission state), as illustrated in FIG. 13C, in the display section 20, eight adjacent sub-pixels SPix to which each of the opening-closing sections 12C is assigned display pieces of pixel information P1 to P8 corresponding to eight perspective images. Then, in the case where the barrier drive section 41 turns the opening-closing sections 12D into the open state (the transmission state), as illustrated in FIG. 13D, in the display section 20, eight adjacent sub-pixels SPix to which each of the opening-closing sections 12D is assigned display pieces of pixel information P1 to P8 corresponding to eight perspective images.

Thus, as will be described later, a viewer may see different perspective images with his left and right eyes, thereby perceiving displayed images as a stereoscopic image. In the stereoscopic display unit 1, images are displayed while the opening-closing sections 12A to 12D perform switching between the open state and the close state in a time-divisional manner; therefore, resolution of the display unit is allowed to be enhanced, as will be described later.

Moreover, in the case where normal display (two-dimensional display) is performed, the display section 20 displays a normal two-dimensional image based on the image signal S2D, and in the barrier section 10, all of the opening-closing sections 11 and the opening-closing sections 12 (the opening-closing sections 12A to 12D) are kept in the open state (in the transmission state). Accordingly, the viewer sees the normal two-dimensional image as it is displayed on the display section 20.

The barrier section 10 corresponds to a specific example of “light-ray control section” in an embodiment of the disclosure. The sub-electrode portions 330 correspond to a specific example of “first structures” in an embodiment of the disclosure. The sub-electrode pitch PE corresponds to a specific example of “first pitch” in an embodiment of the disclosure. The display section 20 corresponds to a specific example of “liquid crystal display section” in an embodiment of the disclosure. The pixel electrodes 212 correspond to a specific example of “second structures” in an embodiment of the disclosure. The sub-pixel pitch PS corresponds to a specific example of “second pitch” in an embodiment of the disclosure.

### [Operation and Function]

Next, an operation and a function of the stereoscopic display unit 1 according to the embodiment will be described below.

### (Brief Description of Entire Operation)

First, referring to FIG. 1 and the like, an entire operation of the stereoscopic display unit 1 will be briefly described below. The control section 40 controls the backlight drive section 43, the barrier drive section 41, and the display drive section 50 based on the image signal Sdisp externally supplied thereto. The backlight drive section 43 drives the backlight 30 based on the backlight control signal supplied from the control section 40. The backlight 30 emits light toward the barrier section 10 by surface emission. The barrier drive section 41 controls the barrier section 10 based on the barrier control signal supplied from the control section 40. The opening-closing sections 11 and 12 of the barrier section 10 perform the open operation and the close operation based on an instruction from the barrier drive section 41. The display drive section 50 drives the display section 20 based on the image signal Sdisp2 supplied from the control section 40. The display section 20 performs display through modulating light which has been emitted from the backlight 30 and has passed through the opening-closing sections 11 and 12 of the barrier section 10.

### (Specific Operation)

Next, a specific operation when stereoscopic display is performed will be described below.

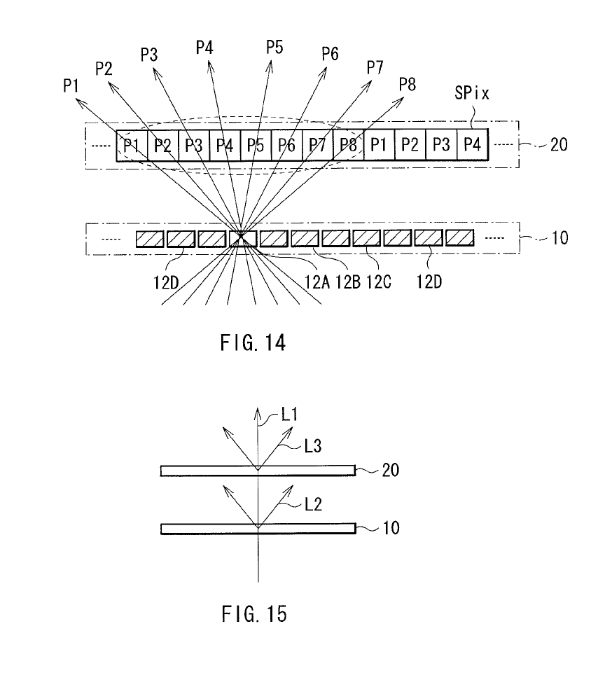

FIG. 14 illustrates operation examples of the display section 20 and the barrier section 10 when the barrier drive section 41 turns the opening-closing sections 12A into the open state (the transmission state). In this case, while the opening-closing section 12A is turned into the open state (the transmission state), the opening-closing sections 12B to 12D are turned into the close state (the blocking state), and sub-pixels SPix disposed around the opening-closing section 12A of the display section 20 display the respective pieces of pixel information P1 to P8 corresponding to eight perspective images included in the image signal S3D. Thus, light rays corresponding to the respective pieces of pixel information P1 to P8 are output with their respective angles limited according to a positional relationship between each of the sub-pixels SPix and the opening-closing section 12A. Accordingly, for example, a viewer viewing from the front of the display screen of the stereoscopic display unit 1 may be allowed to see a stereoscopic image through seeing the pixel information P5 with his left eye and pixel information P4 with his right eye. It is to be noted that, in this case, a case where the barrier drive section 41 turns the opening-closing sections 12A into the open state is described; a similar operation is performed in the case where the opening-closing sections 12B to 12D are turned into the open state.

Thus, the viewer sees different pieces of pixel information from among the pieces of pixel information P1 to P8 with his left eye and his right eye, thereby perceiving such pieces of pixel information as a stereoscopic image. Moreover, since images are displayed while alternately opening and closing the opening-closing sections 12A to 12D in a time-divisional manner, the viewer sees an average of images displayed at positions different from one another. Therefore, the stereoscopic display unit 1 is capable of achieving resolution four times as high as that in the case where only the opening-closing sections 12A are included. In other words, necessary resolution of the stereoscopic display unit 1 is only ½ (=⅛×4) of resolution in the case of two-dimensional display.

### (About Crosstalk)

As illustrated in FIG. 14, during stereoscopic display, it is desirable that the viewer see different perspective images with his left and right eyes. However, as will be described below, the viewer may see a mixture of a perspective image which is supposed to be seen and another perspective image different from the perspective image.

FIG. 15 illustrates scattering of light in the barrier section 10 and the display section 20. During stereoscopic display, light which has been emitted from the backlight 30 and has passed through the opening-closing section 12 in the open state is output through the display section 20 as light L1. At this time, for example, in the barrier section 10 and the display section 20, as indicated by light L2 and light L3, incident light may be diffracted or refracted by electrode patterns or wiring patterns, or may be scattered by the planarizing plate or the like. More specifically, for example, in the case where these electrode patterns or the like are periodically arranged at a narrow structure pitch, light may be strongly scattered.

Thus, when light relating to a certain perspective image is scattered to change its travel direction, the scattered light may be mixed into light relating to another perspective image. In other words, in this case, different perspective images are mixed (crosstalk), and the viewer feels as if image quality is degraded.

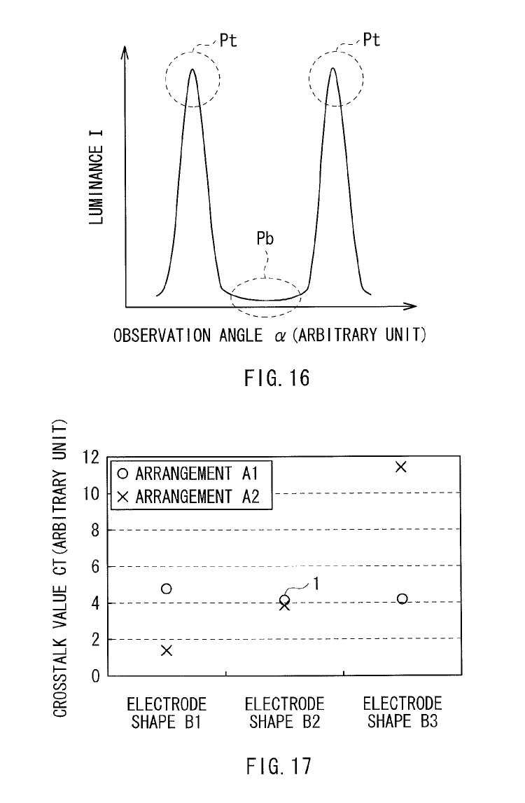

FIG. 16 illustrates crosstalk characteristics of the stereoscopic display unit 1. The crosstalk characteristics illustrated in FIG. 16 are obtained in the following manner. First, the display section 20 displays eight perspective images including a certain perspective image which is entirely white (a white image) and the other perspective images which are entirely black (black images). Then, the barrier section 10 keeps only the opening-closing sections 12 belonging to a certain group (for example, the opening-closing sections 12A belonging to the group A) in the open state (the transmission state), and keeps the opening-closing sections 12 belonging to the other groups in the close state (blocking state). Then, luminance I is measured while changing an observation angle α in a horizontal direction to obtain the crosstalk characteristics illustrated in FIG. 16.

As illustrated in FIG. 16, the luminance I is high (a portion Pt) at the observation angle α at which the viewer sees the light L1 traveling in a straight line illustrated in FIG. 15, and the luminance I is low (a portion Pb) at the observation angle α other than the above-described observation angle α. A part of the luminance I in the portion Pb is caused by scattering of light illustrated in FIG. 15. As the luminance I in the portion Pb is increased, in addition to a perspective image which is supposed to be seen, a perspective image different from the above-described perspective image is displayed, thereby causing degradation in image quality.

In the stereoscopic display unit 1, as illustrated in FIGS. 2A and 2B, the backlight 30, the barrier section 10, and the display section 20 are arranged in this order. Moreover, in the display section 20, as illustrated in FIGS. 7A, 7B and the like, the pixel electrodes 212 are uniformly formed in the respective sub-pixels SPix so as not to provide a fine electrode pattern. In other words, the display section 20 is so configured as to allow a minimum structure pitch to be the sub-pixel pitch PS. Accordingly, crosstalk is allowed to be reduced, as will be described in detail below.

FIG. 17 illustrates crosstalk values CT of stereoscopic display units with various configurations. The crosstalk value CT is determined through dividing the luminance I in the portion Pb by the luminance I in the portion Pt.

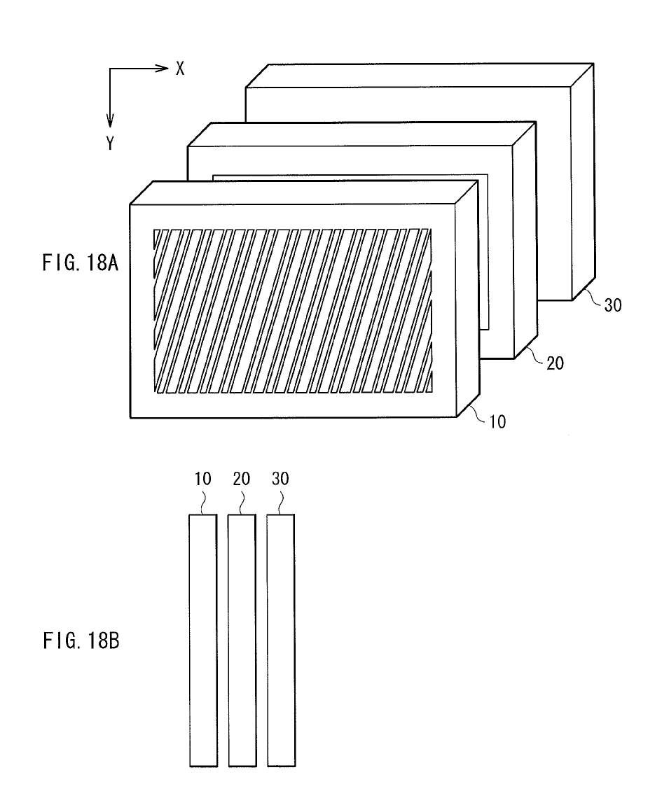

In this example, different arrangements A1 and A2 in which the backlight 30, the barrier section 10, and the display section 20 are arranged in different order are considered. In the arrangement A1, as illustrated in FIGS. 2A and 2B, the backlight 30, the barrier section 10, and the display section 20 are arranged in this order. In other words, in the arrangement A1, the display section 20 is disposed closer to the viewer. On the other hand, in the arrangement A2, as illustrated in FIGS. 18A and 18B, the backlight 30, the display section 20, and the barrier section 10 are arranged in this order. In other words, in the arrangement A2, the barrier section 10 is disposed closer to the viewer.

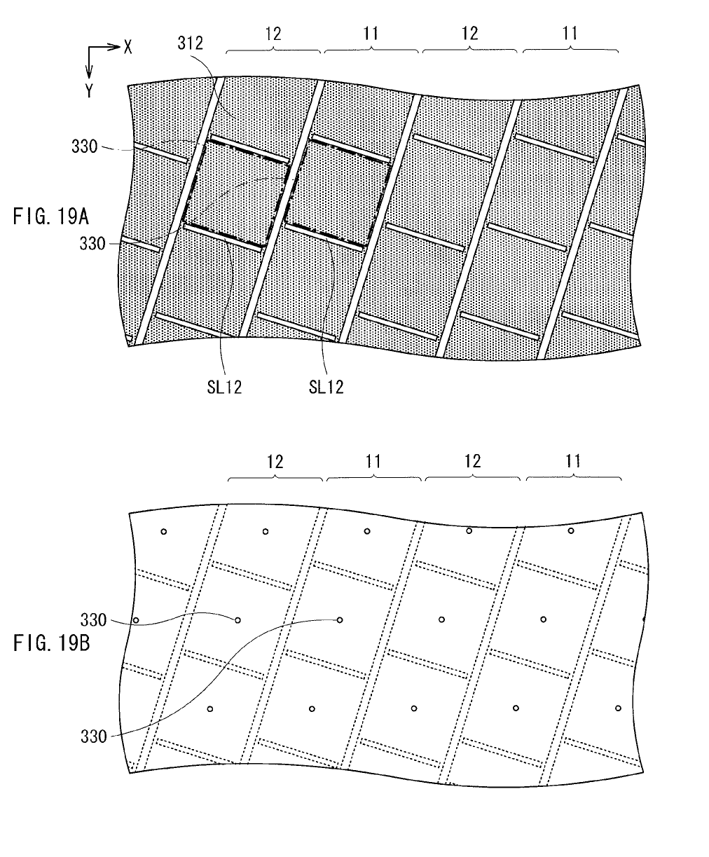

Moreover, in this example, electrode shapes B1 to B3 in which the barrier electrodes 312 in the barrier section 10 have different electrode shapes are considered. In the electrode shape B1, as illustrated in FIGS. 19A and 19B, each of the sub-electrode portions 330 with a size about four times as large as the size of each of the sub-electrode portions 330 illustrated in FIGS. 11A and 11B is formed through removing the slits SL11 and SL13. In the electrode shape B2, each of the barrier electrodes 312 has the shape illustrated in FIGS. 11A and 11B. In the electrode shape B3, although not illustrated, slits are further provided to each of the barrier electrodes 312 to form each of the sub-electrode portions 330 with a size about ¼ of the size of each of the sub-electrode portions 330 illustrated in FIGS. 11A and 11B. In other words, the sub-electrode pitch PE is decreased in the order of the electrode shapes B1, B2, and B3.

In FIG. 17, the crosstalk values CT in six configurations formed through combining one of the arrangements A1 and A2 and one of the electrode shapes B1 to B3 are illustrated. It is to be noted that the stereoscopic display unit 1 corresponds to a combination of the arrangement A1 and the electrode shape B2.

As illustrated in FIG. 17, in the arrangement A2, the crosstalk value CT is increased in the order of the electrode shape B1, B2, and B3, that is, with a decrease in the sub-electrode pitch PE in the barrier section 10. This is caused by scattering in the barrier section 10 disposed closer to the viewer, as will be described below.

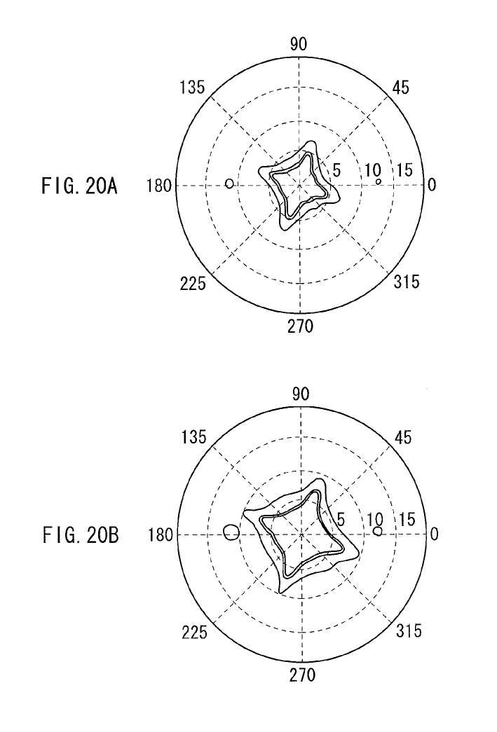

FIGS. 20A and 20B illustrate distributions of transmitted light when only the barrier section 10 is irradiated with laser light. FIG. 20A illustrates a case where the electrode shape B2 is used, and FIG. 20B illustrates a case where the electrode shape B3 is used. A center of a concentric circle corresponds to a position of light traveling in a straight line, and a diameter direction of the concentric circle corresponds to a polar angle. In the case where the electrode shape B3 is used, as described above, compared to the case where the electrode shape B2 is used, the sub-electrode portion 330 is smaller, and the sub-electrode pitch PE is smaller. Therefore, as illustrated in FIG. 20B, in the barrier section 10 with the electrode shape B3, compared to the barrier section 10 with the electrode shape B2 (refer to FIG. 20A), light is scattered in a wider range.

Thus, in the barrier section 10, the smaller the sub-electrode pitch PE is, the more light is scattered. Therefore, even in the case where the barrier section 10 is disposed closer to the viewer (the arrangement A2) to configure the stereoscopic display unit, the smaller the sub-electrode pitch PE is, the more light is scattered, and the luminance I in the portion Pb illustrated in FIG. 16 is thereby increased. Accordingly, as illustrated in FIG. 17, the crosstalk value CT is increased in the order of the electrode shapes B1, B2, and B3.

On the other hand, in the arrangement A1, as illustrated in FIG. 17, the crosstalk value CT is substantially constant in the electrode shapes B1, B2, and B3. In other words, as illustrated in FIGS. 2A and 2B, in the case where the barrier section 10 is disposed between the display section 20 and the backlight 30, even if the sub-electrode pitch PE in the barrier section 10 is changed, the crosstalk value CT is substantially constant, unlike the case of the arrangement A2.

This means that the crosstalk value CT is affected by scattering by the barrier section 10 or the display section 20 which is disoposed closer the viewer. In other words, it is considered that, in the arrangement A2, as illustrated in FIGS. 18A and 18B, since the barrier section 10 is disposed closer to the viewer, scattering by the barrier section 10 contributes to the crosstalk value CT, and on the other hand, in the arrangement A1, as illustrated in FIGS. 2A and 2B, since the display section 20 is disposed closer to the viewer, scattering by the display section 20 contributes to the crosstalk value CT. Accordingly, to reduce the crosstalk value CT, it is considered that the structure pitch in the barrier section 10 or the display section 20 which is disposed closer to the viewer is preferably increased.

In the stereoscopic display unit 1, the display section 20 is disposed closer to the viewer. In the display section 20, as illustrated in FIGS. 7A and 7B, the pixel electrodes 212 are uniformly formed in the sub-pixels SPix. In other words, in the display section 20, the minimum structure pitch is the sub-pixel pitch PS, as illustrated in FIG. 4. Since the electrode pattern is simple in the display section 20, for example, compared to a case where a fine pattern is repeatedly arranged, the structure pitch is allowed to be increased, and scattering is allowed to be reduced. In the stereoscopic display unit 1, since the display section 20 which is capable of suppressing scattering is disposed closer to the viewer, the crosstalk value CT is allowed to be reduced, and since the barrier section 10 is disposed between the display section 20 and the backlight 30, the crosstalk value CT is allowed to be less affected.

Moreover, since an influence of the barrier section 10 on the crosstalk value CT is allowed to be suppressed, a degree of freedom for design of the barrier section 10 is allowed to be increased. More specifically, for example, as will be described below, the barrier section 10 may be so configured as to reduce moire.

### (About Moire)

In general, in a parallax barrier type stereoscopic display unit, opening-closing sections are arranged side by side in a barrier section, and sub-pixels are arranged side by side in a display section; therefore, interference between dark lines generated in the barrier section and a black matrix of the display section may cause moire.

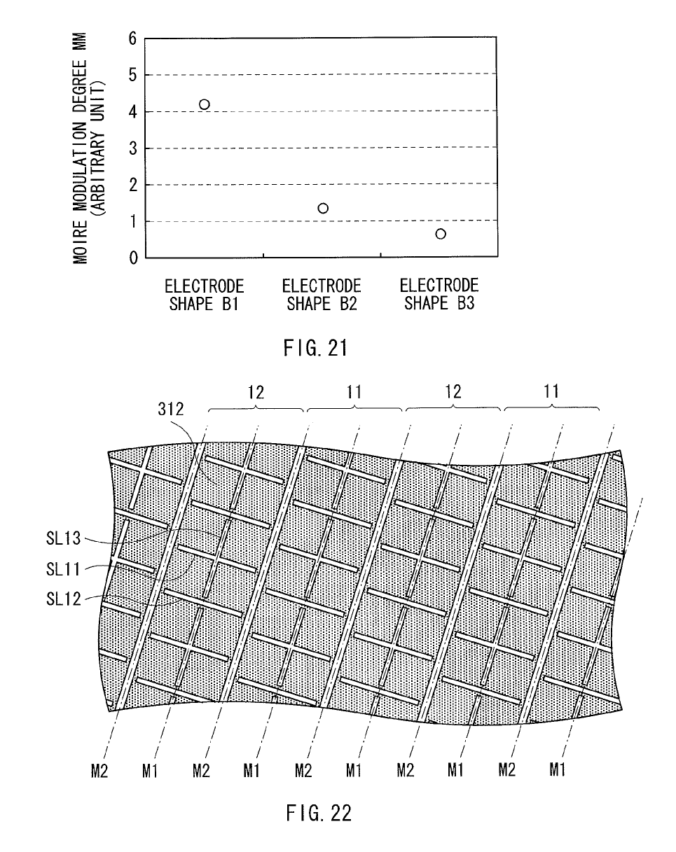

FIG. 21 illustrates moire modulation degrees MM in stereoscopic display units with various configurations. As used herein, the moire modulation degree MM refers to variation in luminance caused by moire in a display screen, and is represented by (maximum luminance value−minimum luminance value)/(maximum luminance value+minimum luminance value). In this example, the moire modulation degrees MM in the electrode shapes B1, B2, and B3 are illustrated. It is to be noted that, in this example, the barrier section 10 is disposed between the display section 20 and the backlight 30 (the arrangement A1).

As illustrated in FIG. 21, the moire modulation degree MM is decreased in the order of the electrode shapes B1, B2, and B3, that is, with a decrease in the sub-electrode pitch PE, because, as will be described below, line density of dark lines is increased with a decrease in the sub-electrode pitch PE.

FIG. 22 illustrates dark lines in the barrier section 10 (the electrode shape B2). In this example, for convenience of description, all of the opening-closing sections 11 and 12 are in the open state (the transmission state). In the barrier section 10, liquid crystal alignment in the liquid crystal layer 300 is not sufficient in portions corresponding to the slits SL11 to SL13 and boundary portions between the barrier electrodes 312; therefore, light does not pass through them sufficiently. In particular, in the portions corresponding to the slits SL13 and the boundary portions between the barrier electrodes 312, regions through which light does not pass sufficiently from a top of the display screen to a bottom of the display screen are formed in lines, thereby forming so-called dark lines M1 and M2. In this example, since the width W12 of each of the opening-closing sections 12 is substantially equal to the sub-pixel pitch PS of the sub-pixel SPix, the line densities of the dark lines M1 and M2 are about twice as high as line density of dark lines in the black matrix BM.

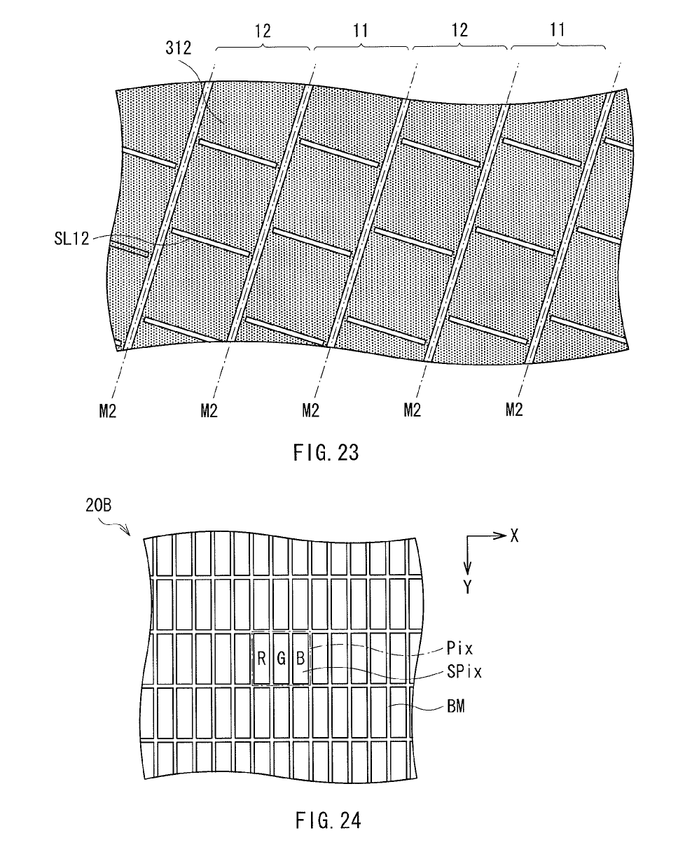

FIG. 23 illustrates dark lines in the case where the barrier electrodes 312 of the barrier section 10 are configured with use of the electrode shape B1. In this case, in particular, in the boundary portions between the barrier electrodes 312, regions through which light does not pass sufficiently from the top of the display screen to the bottom of the display screen are formed in lines to thereby form the dark lines M2. The density of the dark lines in this case is a half of the density of dark lines in the case where the barrier electrodes 312 are configured with use of the electrode shape B2 (refer to FIG. 21). In other words, the line density of the dark lines M2 is substantially equal to the line density of dark lines in the black matrix BM.

Thus, when the sub-electrode pitch PE is reduced, the line density of the dark lines is allowed to be increased. Therefore, as illustrated in FIG. 21, the moire modulation degree MM is allowed to be reduced.

In the stereoscopic display unit 1, the barrier electrodes 312 of the barrier section 10 are configured with use of the electrode shape B2. Thus, as illustrated in FIG. 22, since the line density of dark lines generated in the barrier section 10 is allowed to be increased, moire is allowed to be reduced, and image quality is allowed to be enhanced.

In particular, in the stereoscopic display unit 1, the display section 10 with a larger structure pitch is disposed closer to the viewer, and the barrier section 10 with a smaller structure pitch is disposed closer to the backlight 30; therefore, the crosstalk value CT is allowed to be kept low, moire is allowed to be reduced, and image quality is allowed to be enhanced. In other words, in this example, since the width W12 of each of the opening-closing sections 12 is substantially equal to the sub-pixel pitch PS of the sub-pixel SPix, the sub-electrode pitch PE in the barrier section 10 is smaller than the sub-pixel pitch PS in the display section 20. Therefore, when the display section 10 with a larger structure pitch is disposed closer to the viewer, the crosstalk value CT is allowed to be kept low, and when the barrier section 20 with a smaller structure pitch is disposed closer to the backlight 30, moire is allowed to be reduced while reducing possibility of deteriorating the crosstalk value CT.

### [Effects]

As described above, in the embodiment, since the display section is disposed closer to the viewer, the degree of freedom for design of the barrier section is allowed to be increased.

Moreover, in the embodiment, since the structure pitch is increased through simplifying the configuration of each sub-pixel in the display section, scattering in the display section is allowed to be reduced, crosstalk is allowed to be reduced, and image quality is allowed to be enhanced.

Further, in the embodiment, since the structure pitch in the barrier section is reduced, possibility of generation of moire is allowed to be reduced, and image quality is allowed to be enhanced. In particular, since the structure pitch in the display section is smaller than the structure pitch in the barrier section, possibility of generation of moire is allowed to be reduced while suppressing deterioration in crosstalk.

### [Modification 1-1]

In the above-described embodiment, the alignment films 213 and 223 are subjected to so-called photo-alignment treatment; however, the alignment films 213 and 223 is not exclusively subjected to the photo-alignment treatment, and may be subjected to, for example, so-called rubbing.

### [Modification 1-2]

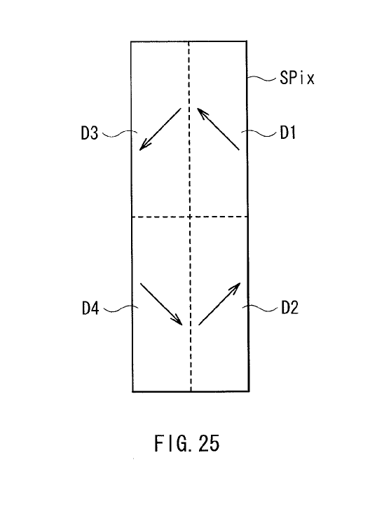

In the above-described embodiment, each of the sub-pixels SPix includes the sub-pixel portions PA and PB; however, the configuration of each of the sub-pixels SPix is not limited thereto. For example, as illustrated in FIG. 24, each of the sub-pixels SPix may not include sub-pixel portions, and may be driven as one unit. In this case, as illustrated in FIG. 25, each of the sub-pixels SPix preferably includes four domains D1 to D4.

### [Modification 1-3]

In the above-described embodiment, in the display section 20, the alignment films 213 and 223 are subjected to the photo-alignment treatment to form the domains D1 to D4; however, the embodiment is not limited thereto. For example, slits may be formed in the pixel electrode or the like to form a plurality of domains. A stereoscopic display unit 1C according to this modification will be described in detail below.

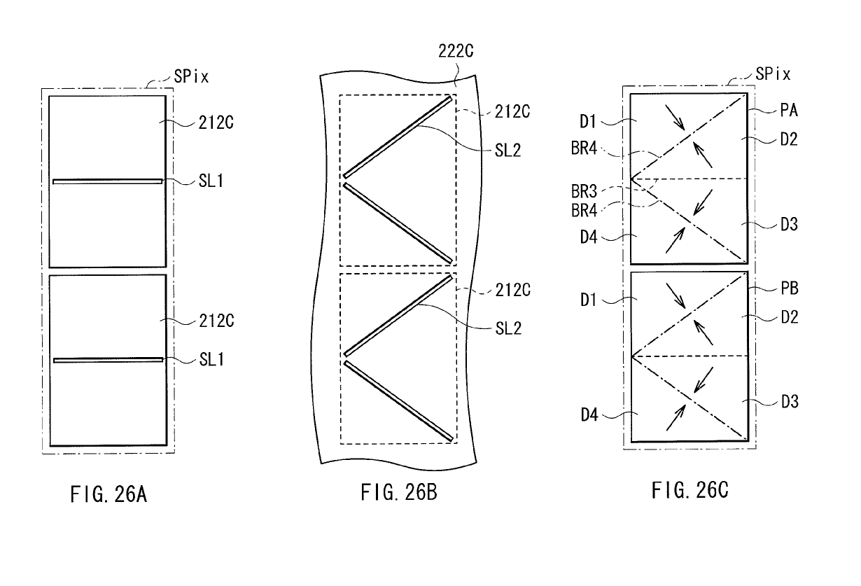

FIGS. 26A to 26C illustrate a configuration example of a display section 20C according to this modification. FIG. 26A illustrates a pixel electrode 212C, FIG. 26B illustrates a counter electrode 222C, and FIG. 26C schematically illustrates an average alignment direction of liquid crystal molecules M in the sub-pixel SPix.

The pixel electrodes 212C in the sub-pixel portions PA and PB are formed in a similar electrode pattern. As illustrated in FIG. 26A, one slit SL1 is formed in each of the pixel electrodes 212C. In this example, the slit SL1 is so formed as to extend in the horizontal direction X around a center of the pixel electrode 212C.

As illustrated in FIG. 26B, in the counter electrode 222C, two slits SL2 are formed in each of the sub-pixel portions PA and PB. In this example, one of the two slit SL2 is so formed as to extend in a direction from bottom left to top right in an upper half of each of the sub-pixel portions PA and PB, and the other slit SL2 is so formed as to extend in a direction from top left to bottom right in a lower half of each of the sub-pixel portions PA and PB. Also in this configuration, the minimum structure pitch is the sub-pixel pitch PS.

Thus, as illustrated in FIG. 26C, four domains D1 to D4 are formed in each of the sub-pixels SPix. In other words, the domains D1 and D2 are formed through separating the upper half of each of the sub-pixel portions PA and PB by a domain boundary BR4 corresponding to the slit SL2, and the domains D3 and D4 are formed through separating the lower half of each of the sub-pixel portions PA and PB by the domain boundary BR4. Moreover, the domains D2 and D3 are separated by a domain boundary BR3 corresponding to the slit SL1.

Thus, each of the sub-pixel portions PA and PB includes four domains D1 to D4. At this time, in the display section 20C, the number of slits SL1 and the number of slits SL2 are reduced to form the domains D1 to D4 in respective closed regions: therefore, the structure pitch is allowed to be increased, and possibility of scattering of light is allowed to be reduced. Thus, in the stereoscopic display unit 1C according to this modification, the crosstalk value CT is allowed to be reduced, and image quality is allowed to be enhanced accordingly.

Moreover, as with Modification 2-2 of a second embodiment which will be described later, the liquid crystal molecules M may be pretilted by UV irradiation. In this case, the alignment direction of the liquid crystal molecules M is allowed to be further stabilized, and response time is allowed to be reduced.

### [Modification 1-4]

In the above-described embodiment, in the display section 20, four domains D1 to D4 are formed; however, the embodiment is not limited thereto. For example, pinholes may be formed in the counter electrode to successively arrange domains. A stereoscopic display unit 1D according to this modification will be described in detail below.

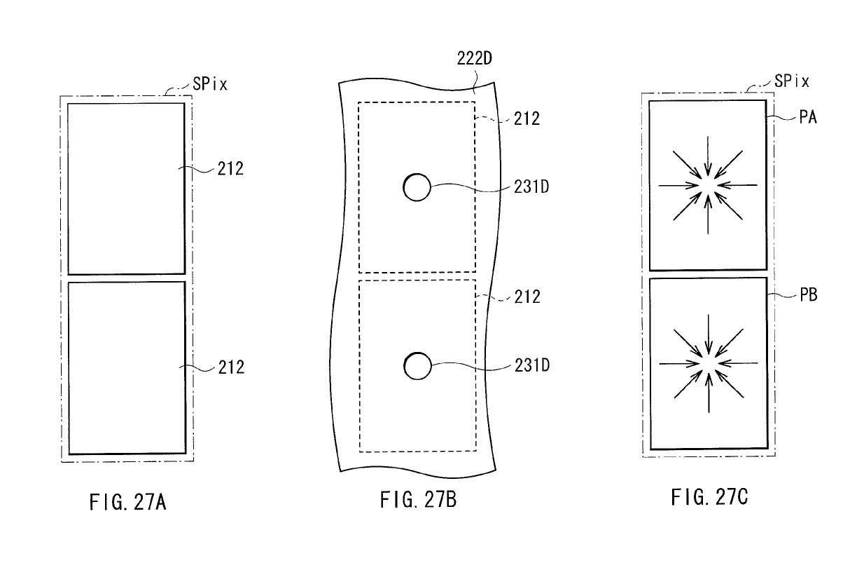

FIGS. 27A to 27C illustrate a configuration example of a display section 20D according to this modification. FIG. 27A illustrates the pixel electrode 212, FIG. 27B illustrates a counter electrode 222D, and FIG. 27C schematically illustrates an average alignment direction of the liquid crystal molecules M in the sub-pixel SPix. As illustrated in FIG. 27B, in the counter electrode 222D, holes 231D are formed in respective regions corresponding to the sub-pixel portions PA and PB. In this example, each of the holes 231D is formed at a position corresponding to a center of each of the pixel electrodes 212. Therefore, in the sub-pixel SPix, as illustrated in FIG. 27C, the liquid crystal molecules M are radially aligned in each of the sub-pixel portions PA and PB. In other words, in each of the sub-pixel portions PA and PB, very small domains are radically arranged. Also in this configuration, the minimum structure pitch is the sub-pixel pitch PS.

In the display section 20D, the pixel electrodes 212 are uniformly formed in the sub-pixel portions PA and PB, and the counter electrode 222D is also uniformly formed, except for the holes 231D; therefore, the structure pitch is allowed to be increased, and possibility of scattering of light is allowed to be reduced. Thus, in the stereoscopic display unit 1D according to this modification, the crosstalk value CT is allowed to be reduced, and image quality is allowed to be enhanced accordingly.

### [Modification 1-5]

In the above-described embodiment, the VA type display section 20 is used; however, the embodiment is not limited thereto. For example, a TN (Twisted Nematic) type display section may be used. A stereoscopic display unit 1E according to this modification will be described in detail below.

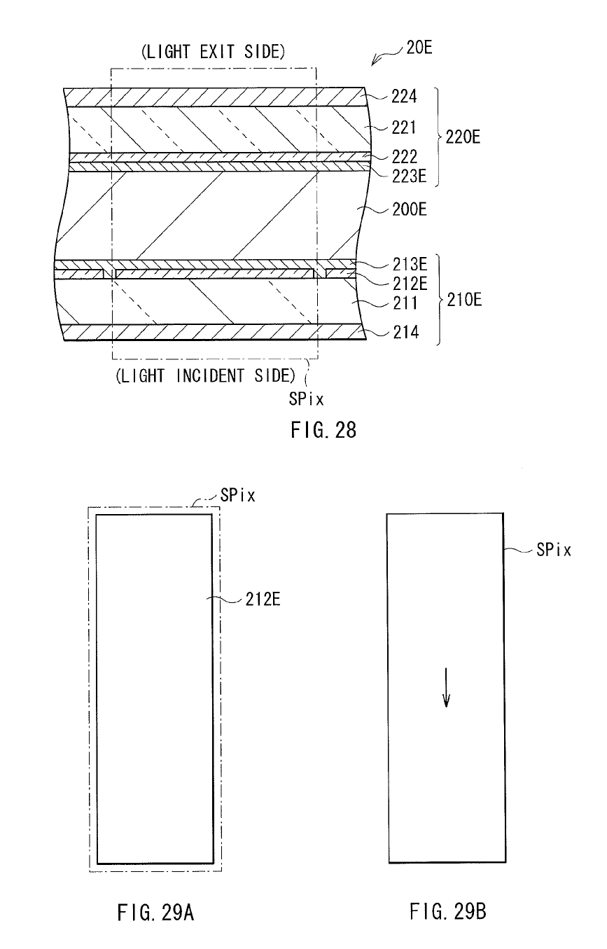

FIG. 28 illustrates a configuration example of a display section 20E. The display section 20E is different from the display section 20 according to the above-described embodiment in that the sub-pixel portions are not provided, and the sub-pixel SPix is driven as one unit.

The display section 20E includes a drive substrate 210E, a counter substrate 220E, and a liquid crystal layer 200E. The drive substrate 210E includes pixel electrodes 212E and an alignment film 213E. Each of the pixel electrodes 212E may be configured of, for example, a transparent conductive film of ITO or the like, and is uniformly formed in a region corresponding to each of the sub-pixels SPix. The alignment film 213E is formed on the pixel electrodes 212E. The counter substrate 220E includes an alignment film 223E. As will be described later, a direction (an alignment direction) in which the liquid crystal molecules M are aligned by the alignment film 223E is set to intersect with a direction in which the liquid crystal molecules M are aligned by the alignment film 213E. The liquid crystal layer 200E is made of a TN liquid crystal.

FIGS. 29A and 29B illustrate a configuration example of the display section 20E. FIG. 29A illustrates the pixel electrode 212E, and the FIG. 29B schematically illustrates an average alignment direction of the liquid crystal molecules M in the sub-pixel SPix. As illustrated in FIG. 29A, each of the pixel electrodes 212E is uniformly formed in each of the sub-pixels SPix. Moreover, as illustrated in FIG. 29B, the display section 20E operates to align the liquid crystal molecules M in a uniform direction in each of the sub-pixels SPix. In other words, the display section 20E is a single-domain display panel. Also in this configuration, the minimum structure pitch is the sub-pixel pitch PS.

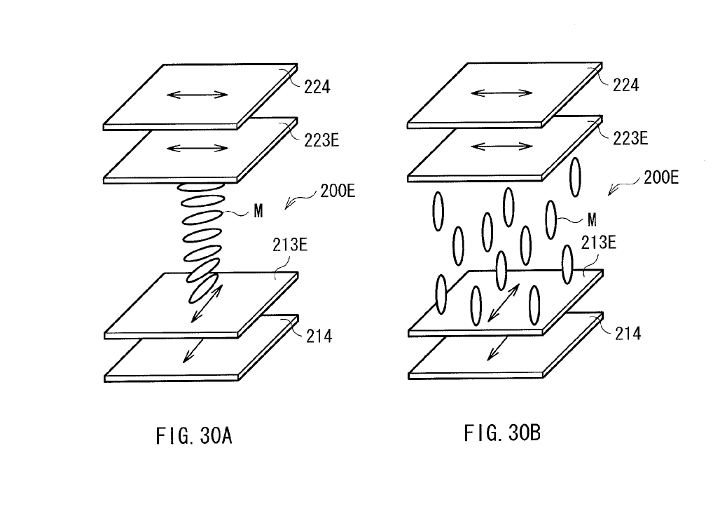

FIGS. 30A and 30B schematically illustrate an operation of the liquid crystal layer 200E in the case where a potential difference does not exist between the pixel electrode 212E and the counter electrode 222 and in the case where a potential difference exists between the pixel electrode 212E and the counter electrode 222, respectively.

In the case where a potential difference does not exist, as illustrated in FIG. 30A, long axes of the liquid crystal molecules M in the liquid crystal layer 200E are aligned in a direction parallel to a substrate surface of the drive substrate 210E or the counter substrate 220E. Long axes of liquid crystal molecules M in proximity to the alignment film 213E are aligned in a predetermined direction by the alignment film 213E, and long axes of liquid crystal molecules M in proximity to the alignment film 223E are aligned in a predetermined direction by the alignment film 223E. At this time, the alignment direction of the liquid crystal molecules M aligned by the alignment film 213E and the alignment direction of the liquid crystal molecules M aligned by the alignment film 223E intersect with each other, and liquid crystal molecules M in the liquid crystal layer 200E are so aligned as to be twisted.

On the other hand, in the case where a potential difference exists, as illustrated in FIG. 30B, long axes of the liquid crystal molecules M in the liquid crystal layer 200E are aligned in a direction perpendicular to the substrate surface of the drive substrate 210E or the counter substrate 220E.

In the display section 20E, since each of the pixel electrodes 212E is uniformly formed in each of the sub-pixels SPix, the structure pitch is allowed to be increased, and possibility of scattering of light is allowed to be reduced. Therefore, in the stereoscopic display unit 1E according to this modification, the crosstalk value CT is allowed to be reduced, and image quality is allowed to be enhanced accordingly.

### [Modification 1-6]

In the above-described embodiment, the display section 20 is disposed closer to the viewer, and the barrier section 10 is disposed closer to the backlight 30; however, the embodiment is not limited thereto. For example, the barrier section 10 may be disposed closer to the viewer, and the display section 20 may be disposed closer to the backlight 30. In this case, the structure pitch in the barrier section 10 is preferably larger than the structure pitch in the display section 20. Thus, scattering in the barrier section 10 is allowed to be reduced, and the crosstalk value CT is less affected by the display section 20 while reducing crosstalk; therefore, the degree of freedom for design of the display section 20 is allowed to be increased.

### 2. SECOND EMBODIMENT

Next, a stereoscopic display unit 2 according to the second embodiment will be described below. In the embodiment, each of the opening-closing sections 11 and 12 is configured of a liquid crystal barrier including four domains. It is to be noted that like components are denoted by like numerals as of the stereoscopic display unit 1 according to the above-described first embodiment and will not be further described.

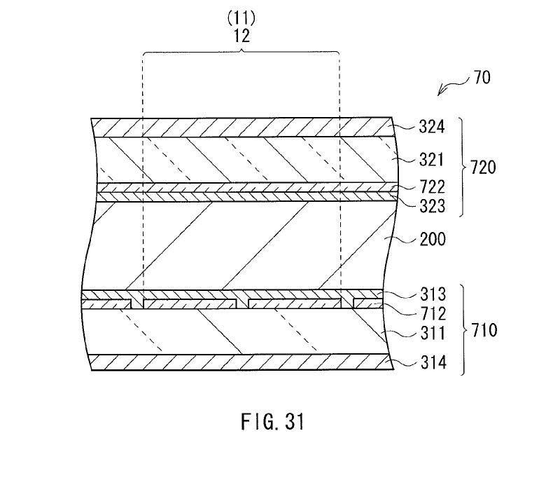

FIG. 31 illustrates a sectional configuration example of a barrier section 70 according to the embodiment. The barrier section 70 includes a drive substrate 710 and a counter substrate 720. The drive substrate 710 includes barrier electrodes 712. The barrier electrodes 712 are disposed in respective regions corresponding to the opening-closing sections 11 and 12, as with the barrier electrodes 312 according to the first embodiment. Each of the barrier electrodes 712 may be configured of, for example, a transparent conductive film of ITO or the like, and includes trunk portions 81 and 82 and branch portions 83, as will be described later. The counter substrate 720 includes a counter electrode 722. The counter electrode 722 is uniformly formed throughout the barrier section 70.

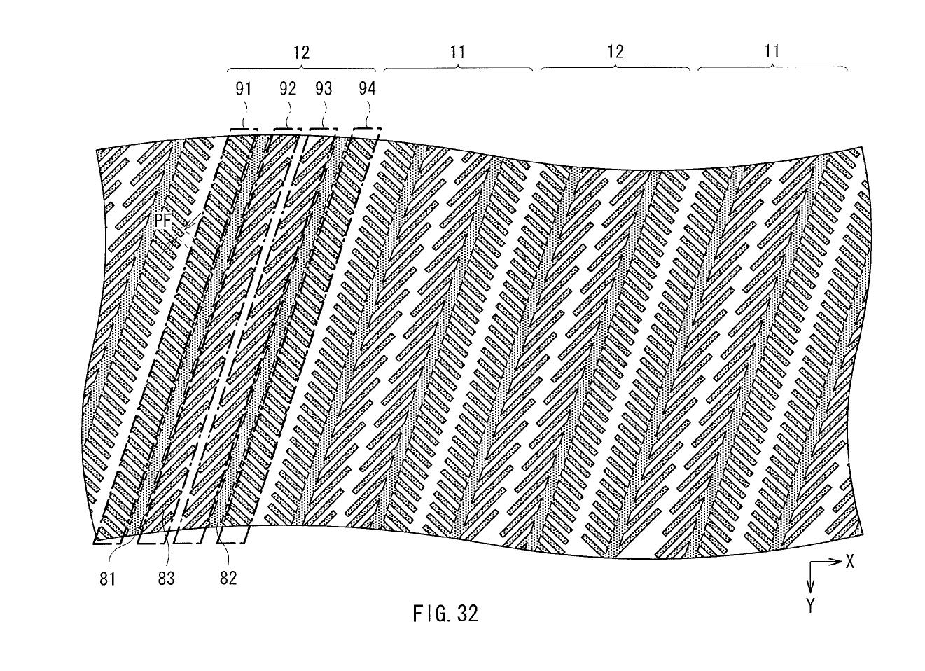

FIG. 32 illustrates a configuration example of the barrier electrode 712. Each of the barrier electrodes 712 includes trunk portions 81 and 82, and branch portions 83. The trunk portions 81 and 82 are formed separately from each other, and are so formed as to extend in an extending direction of the barrier electrodes 712. The branch portions 83 in two branch regions 91 and 92 provided at both sides of the trunk portion 81 are so formed as to extend from the trunk portion 81 and as to be arranged at a branch pitch PF, and the branch portions 83 in two branch regions 93 and 94 provided at both sides of the trunk portion 82 are so formed as to extend from the trunk portion 82 and as to be arranged at the branch pitch PF. The branch portions 83 in each of the branch regions 91 to 94 extend in a same direction. The branch portions 83 in each of the branch regions 91 and 94 extend in a direction rotated clockwise by a predetermined angle φ (for example, 45°) from the horizontal direction X, and the branch portions 83 in each of the branch regions 92 and 93 extend in a direction rotated counterclockwise by a predetermined angle φ (for example, 45°) from the horizontal direction X. In this configuration, four domains corresponding to the branch regions 91 to 94 are formed in each of the opening-closing sections 11 and 12 of the barrier section 70.

The branch portions 83 corresponds to a specific example of “first structures” in an embodiment of the disclosure. The branch pitch PF corresponds to a specific example of “first pitch” in an embodiment of the disclosure.

Thus, in the barrier section 70, in each of the branch regions 91 to 94, the branch portions 83 are arranged at the branch pitch PF. Therefore, a minimum structure pitch in the barrier section 70 is the branch pith PF. Accordingly, also in this case, the structure pitch in the barrier section 70 is allowed to be smaller than the sub-pixel pitch PS in the display section 20.

As described above, in the embodiment, four domains are formed in each of the opening-closing sections; therefore, viewing angle characteristics are allowed to be enhanced. Other effects are similar to those in the first embodiment.

### [Modification 2-1]

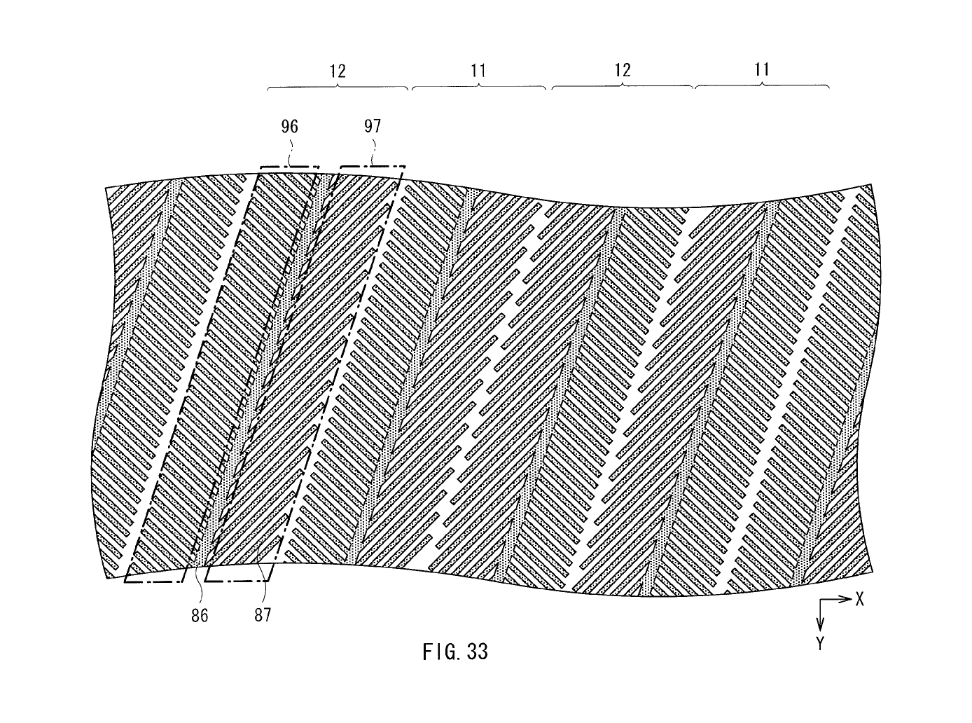

In the above-described embodiment, in the barrier section 70, each of the opening-closing sections 11 and 12 are so configured as to include two trunk portions 81 and 82; however, the configurations of the opening-closing sections 11 and 12 are not limited thereto. For example, as illustrated in FIG. 33, each of the opening-closing sections 11 and 12 may be so configured as to include one trunk portion 86. Also in this configuration, the minimum structure pitch in the barrier section 70 is the branch pitch PF.

### [Modification 2-2]

In the above-described embodiment, in the display section 20, the alignment films 213 and 223 are subjected to photo-alignment treatment to form the domains D1 to D4; however, the embodiment is not limited thereto. A transparent electrode for determining alignment of the liquid crystal molecules M may be further provided. A stereoscopic display unit 2F according to this modification will be described in detail below.

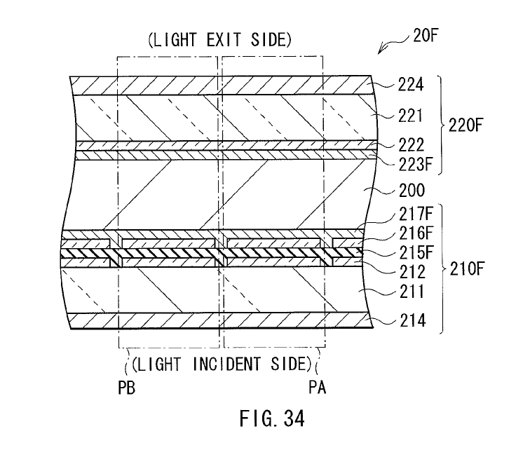

FIG. 34 illustrates a sectional configuration example of a display section 20F according to this modification. The display section 20F includes a drive substrate 210F and a counter substrate 220F. The drive substrate 210F includes an insulating layer 215F, transparent electrodes 216F, and an alignment film 217F. The insulating layer 215F is formed on the pixel electrodes 212. The insulating layer 215F may be made of, for example, SiN. The transparent electrodes 216F are formed in respective regions corresponding to the sub-pixel portions PA and PB on the insulating layer 215F. Each of the transparent electrodes 216F may be configured of, for example, a transparent conductive film of ITO or the like, and includes trunk portions 61 and 62 and branch portions 63, as will be described later. The alignment film 217F is formed on the transparent electrodes 216F. The counter substrate 220F includes an alignment film 223F. The alignment film 223F is formed on the counter electrode 222. In this example, an UV-curable monomer is mixed in the liquid crystal layer 200.

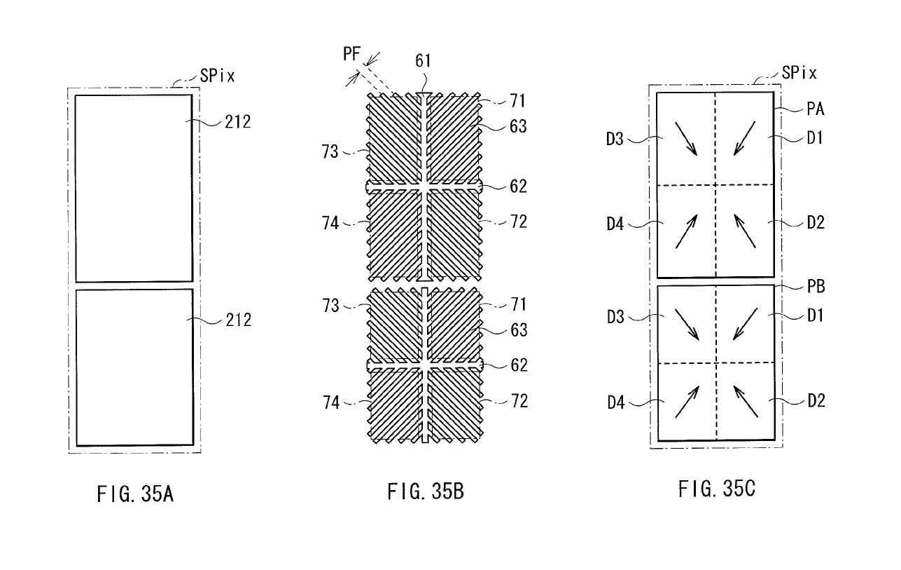

FIGS. 35A, 35B, and 35C illustrate a configuration example of the display section 20F. FIG. 35A illustrates the pixel electrode 212, FIG. 35B illustrates the transparent electrode 216F, and FIG. 35C schematically illustrates alignment of liquid crystal molecules M in the sub-pixel SPix.

The transparent electrodes 216F in the sub-pixel portions PA and PB are formed in a similar electrode pattern. As illustrated in FIG. 35B, each of the transparent electrodes 216F includes the trunk portions 61 and 62, and the branch portions 63. The trunk portion 61 is so formed as to extend in the vertical direction Y, and the trunk portion 62 is so formed as to extend in the horizontal direction X and as to intersect with the trunk portion 61. The branch portions 63 in each of four branch regions 71 to 74 separated by the trunk portion 61 and the trunk portion 62 are so formed as to extend from the trunk portion 61 and the trunk portion 62.

The branch portions 63 in each of the branch regions 71 to 74 extend in a same direction. An extending direction of the branch portions 63 in the branch region 71 and an extending direction of the branch portions 63 in the branch region 73 are line-symmetrically arranged with respect to the vertical direction Y as an axis, and an extending direction of the branch portions 63 in the branch region 72 and an extending direction of the branch portions 63 in the branch region 74 are line-symmetrically arranged with respect to the vertical direction Y as an axis in a similar manner. Moreover, the extending direction of the branch portions 63 in the branch region 71 and the extending direction of the branch portions 63 in the branch region 72 are line-symmetrically arranged with respect to the horizontal direction as an axis, and the extending direction of the branch portions 63 in the branch region 73 and the extending direction of the branch portions 63 in the branch region 74 are line-symmetrically arranged with respect to the horizontal direction X as an axis in a similar manner. In this example, more specifically, the branch portions 63 in each of the branch regions 71 and 74 extend in a direction rotated counterclockwise by a predetermined angle φ (for example, 45°) from the horizontal direction X, and the branch portions 63 in each of the branch regions 72 and 73 extend in a direction rotated clockwise by a predetermined angle φ (for example, 45°) from the horizontal direction X. In this configuration, the minimum structure pitch in the display section 20F is the branch pitch PF.

In a process of manufacturing the display section 20F, after the display section 20F is assembled, the display section 20F is irradiated with UV light while applying a voltage between the transparent electrodes 216F and the counter electrode 222 so as to pretilt the liquid crystal molecules M in the liquid crystal layer 200, thereby determining alignment of the liquid crystal molecules M. Therefore, as illustrated in FIG. 35C, in each of the sub-pixels SPix, four domains D1 to D4 are formed in each of the sub-pixel portions PA and PB. The domains D1 to D4 are formed corresponding to the branch regions 91 to 94, respectively.

When the display section 20F performs a display operation, a same pixel signal is applied to, for example, the pixel electrode 212 and the transparent electrode 216F corresponding to the pixel electrode 212. Therefore, in the display section 20F, since the liquid crystal layer 200 is driven by mainly a potential difference between the pixel electrode 212 and the counter electrode 222, an electric field is allowed to be substantially flat, and scattering of light in the liquid crystal layer 200 is allowed to be reduced. Thus, in the stereoscopic display unit 1F according to this modification, the crosstalk value CT is allowed to be reduced, and image quality is allowed to be enhanced accordingly.

In particular, in the case where the branch pitch PF in the barrier section 70 is smaller than the branch pitch PF in the display section 20F, moire is allowed to be reduced, and uniformity of a luminance distribution in a display surface is allowed to be enhanced.

### 3. APPLICATION EXAMPLES

Next, application examples of the stereoscopic display units described in the above-described embodiments and the modifications thereof will be described below.

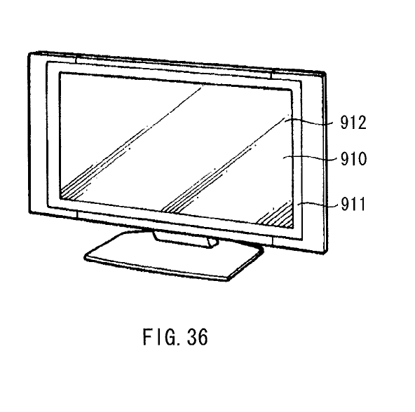

FIG. 36 illustrates an appearance of a television to which any one of the stereoscopic display units according to the above-described embodiments and the like is applied. The television may include, for example, an image display screen section 910 including a front panel 911 and a filter glass 912. The television is configured of any one of the stereoscopic display units according to the above-described embodiments and the like.

The stereoscopic display units according to the above-described embodiments and the like are applicable to, in addition to such a television, electronic apparatuses in any fields, including digital cameras, notebook personal computers, portable terminal devices such as cellular phones, portable game machines, and video cameras. In other words, the stereoscopic display units according to the above-described embodiments and the like are applicable to electronic apparatuses in any fields displaying an image.

Although the technology of the present disclosure is described referring to some embodiments, the modifications, and the application examples to electronic apparatuses, the technology is not limited thereto, and may be variously modified.

For example, in the above-described embodiments and the like, the barrier section 10 is configured of VA type liquid crystal barriers; however, the barrier section 10 is not limited thereto, and may be configured of TN type liquid crystal barriers.

Moreover, for example, in the above-described embodiments and the like, four domains are formed in each of the sub-pixel portions PA and PB; however, the number of domains are not limited to four. For example, three or less domains or five or more domains may be formed in each of the sub-pixel portions PA and PB.

Further, for example, in the above-described embodiments and the like, the opening-closing sections 12 are divided into four groups; however, the number of groups is not limited thereto, and the opening-closing sections 12 may be divided into three or less groups, or five or more groups. Moreover, the opening-closing sections 12 may not be divided into groups. In this case, the opening-closing sections are constantly in the open state (the transmission state) during stereoscopic display.

For example, in the above-described embodiments and the like, eight perspective images are displayed during stereoscopic display; however, the number of perspective images to be displayed is not limited thereto, and seven or less perspective images or nine or more perspective images may be displayed. In this case, a relative positional relationship between the opening-closing sections 12A to 12D of the barrier section 10 and the sub-pixels SPix illustrated in FIGS. 11A and 11B is also varied. More specifically, for example, in the case where nine perspective images are displayed, each one of the opening-closing sections 12A to 12D may be assigned to nine sub-pixels SPix in the display section 20.

For example, the stereoscopic display units in the above-described embodiments and the like are of a parallax barrier type; however, the stereoscopic display units are not limited thereto, and may be of, for example, a lenticular lens type.

It is to be noted that the technology is allowed to have the following configurations.

(1) A display unit including:

a light-ray control section including first structures, the first structures being arranged at a first pitch;

a liquid crystal display section including second structures, the second structures being arranged at a second pitch; and

a backlight,

in which one in which a structure arrangement pitch is smaller of the liquid crystal display section and the light-ray control section is disposed between the other one of the liquid crystal display section and the light-ray control section, and the backlight.

(2) The display unit according to (1), in which

the first pitch is smaller than the second pitch, and

the light-ray control section is disposed between the liquid crystal display section and the backlight.

(3) The display unit according to (2), in which the light-ray control section includes a plurality of liquid crystal barriers, the liquid crystal barriers being switchable between an open state and a close state, and extending in a first direction.

(4) The display unit according to (3), in which

first electrodes disposed in regions corresponding to the liquid crystal barriers, each of the first electrodes including a plurality of sub-electrodes, the sub-electrodes being arranged side by side,

a second electrode disposed in a common region corresponding to the plurality of liquid crystal barriers, and having holes at positions corresponding to the respective sub-electrodes, and

a first liquid crystal layer disposed between the first electrodes and the second electrode, and

the first structures are the sub-electrodes.

(5) The display unit according to (4), in which

each of the first electrodes includes one or more first slits extending in the first direction and a plurality of second slits extending in a second direction, the second direction intersecting with the first direction, and

the plurality of sub-electrodes are separated by the one or more first slits and the second slits.

(6) The display unit according to (3), in which

the light-ray control section includes

first electrodes disposed in regions corresponding to the liquid crystal barriers, each of the first electrodes including a first trunk portion and a plurality of branch portions, the first trunk portion extending in the first direction, the first branch portions being arranged side by side and extending from the trunk portion,

a second electrode disposed in a common region corresponding to the plurality of liquid crystal barriers, and

a first liquid crystal layer disposed between the first electrodes and the second electrode, and

the first structures are the first branch portions.

(7) The display unit according to (6), in which the plurality of first branch portions are formed at both sides of the first trunk portion.

(8) The display unit according to (2), in which

the liquid crystal display section includes

third electrodes corresponding to a plurality of unit pixels,

a fourth electrode disposed in a common region corresponding to the plurality of unit pixels, and

a second liquid crystal layer disposed between the third electrodes and the fourth electrode,

each of the unit pixels includes a plurality of domains or a single domain, the plurality of domains in which liquid crystal alignment in the second liquid crystal layer differs between the domains, and

each of the third electrodes is uniformly formed in each of the plurality of domains or the single domain.

(9) The display unit according to (8), in which

each of the unit pixels includes a plurality of domains, and

each of the domains is configured as a one successive region.

(10) The display unit according to (9), in which

the liquid crystal display section includes

a first alignment film disposed between the second liquid crystal layer and the third electrodes, and including a plurality of first alignment regions determining the liquid crystal alignment, and

a second alignment film disposed between the second liquid crystal layer and the fourth electrode, and including a plurality of second alignment regions determining the liquid crystal alignment,

the domains are regions determined by the first alignment regions and the second alignment regions, and

the second structures are the third electrodes.

(11) The display unit according to (10), in which

the first alignment film includes two first alignment regions in a region corresponding to each of the unit pixels, the two first alignment regions being arranged side by side,

the second alignment film includes two second alignment regions in a region corresponding to each of the unit pixels, the two second alignment regions being arranged side by side in a direction intersecting with a direction in which the two first alignment regions are arranged side by side, and

each of the unit pixels includes four domains.

(12) The display unit according to (9), in which

the liquid crystal display section includes a fifth electrode disposed between the third electrodes and the second liquid crystal layer,

the fifth electrode includes a plurality of branch regions, each of the branch regions including second branch portions extending in a same direction,

the domains are regions corresponding to the branch regions, and

the second structures are the second branch portions.

(13) The display unit according to (12), in which

the fifth electrode further includes

a second trunk portion, and

a third trunk portion intersecting with the second trunk portion,

the branch regions are four regions separated by the second trunk portion and the third trunk portion, and

the branch portions in the respective branch regions extend from the second trunk portion and the third trunk portion in a direction differing between the branch regions.

(14) The display unit according to (9), in which

each of the third electrodes includes one or two third slits,

the fourth electrode includes one or two fourth slits in a region corresponding to each of the unit pixels, the one or two fourth slits being formed in portions different from the one or two third slits, and

the domains are regions determined by the one or two third silts and the one or two fourth slits.

(15) The display unit according to (14), in which

each of the third electrodes includes one third slit, and

the fourth electrode includes one fourth slit in each of two sub-regions formed through separating a region corresponding to each of the unit pixels by the third slit.

(16) The display unit according to (9), in which

the fourth electrode includes holes in portions corresponding to the unit pixels, and

the domains are regions arranged around each of the holes.

(17) The display unit according to (8), in which

each of the unit pixels includes a single domain,

the liquid crystal layer is made of a TN liquid crystal, and

the domain is a region corresponding to each of the unit pixels.

(18) The display unit according to any one of (9) to (16), in which

each of the unit pixels includes a plurality of domains, and

areas of the domains are substantially equal to one another.

(19) The display unit according to any one of (8) to (18), in which

the liquid crystal display section includes a plurality of pixels,

each of the pixels includes a plurality of sub-pixels, and

each of the sub-pixels includes a plurality of the unit pixels.

(20) The display unit according to any one of (8) to (18), in which

the liquid crystal display section includes a plurality of pixels,

each of the pixels includes a plurality of sub-pixels, and

the sub-pixels are the unit pixels.

(21) An electronic apparatus provided with a display unit and a control section which performs operation control with use of the display unit, the display unit including:

a light-ray control section including first structures, the first structures being arranged at a first pitch;

a liquid crystal display section including second structures, the second structures being arranged at a second pitch; and

a backlight,

in which one in which a structure arrangement pitch is smaller of the liquid crystal display section and the light-ray control section is disposed between the other one of the liquid crystal display section and the light-ray control section, and the backlight.

The present disclosure contains subject matter related to that disclosed in Japanese Priority Patent Application No. 2012-154365 filed in the Japan Patent Office on Jul. 10, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a light-ray control section including first structures, the first structures being arranged at a first pitch;
a liquid crystal display section including second structures, the second structures being arranged at a second pitch; and
a backlight,
wherein one in which a structure arrangement pitch is smaller of the liquid crystal display section and the light-ray control section is disposed between the other one of the liquid crystal display section and the light-ray control section, and the backlight.

2. The display unit according to claim 1, wherein
the first pitch is smaller than the second pitch, and
the light-ray control section is disposed between the liquid crystal display section and the backlight.

3. The display unit according to claim 2, wherein the light-ray control section includes a plurality of liquid crystal barriers, the liquid crystal barriers being switchable between an open state and a close state, and extending in a first direction.

4. The display unit according to claim 3, wherein
the light-ray control section includes
first electrodes disposed in regions corresponding to the liquid crystal barriers, each of the first electrodes including a plurality of sub-electrodes, the sub-electrodes being arranged side by side,
a second electrode disposed in a common region corresponding to the plurality of liquid crystal barriers, and having holes at positions corresponding to the respective sub-electrodes, and
a first liquid crystal layer disposed between the first electrodes and the second electrode, and
the first structures are the sub-electrodes.

5. The display unit according to claim 4, wherein
each of the first electrodes includes one or more first slits extending in the first direction and a plurality of second slits extending in a second direction, the second direction intersecting with the first direction, and
the plurality of sub-electrodes are separated by the one or more first slits and the second slits.

6. The display unit according to claim 3, wherein
the light-ray control section includes
first electrodes disposed in regions corresponding to the liquid crystal barriers, each of the first electrodes including a first trunk portion and a plurality of branch portions, the first trunk portion extending in the first direction, the first branch portions being arranged side by side and extending from the trunk portion,
a second electrode disposed in a common region corresponding to the plurality of liquid crystal barriers, and
a first liquid crystal layer disposed between the first electrodes and the second electrode, and
the first structures are the first branch portions.

7. The display unit according to claim 6, wherein the plurality of first branch portions are formed at both sides of the first trunk portion.

8. The display unit according to claim 2, wherein
the liquid crystal display section includes
third electrodes corresponding to a plurality of unit pixels,
a fourth electrode disposed in a common region corresponding to the plurality of unit pixels, and
a second liquid crystal layer disposed between the third electrodes and the fourth electrode,
each of the unit pixels includes a plurality of domains or a single domain, the plurality of domains in which liquid crystal alignment in the second liquid crystal layer differs between the domains, and
each of the third electrodes is uniformly formed in each of the plurality of domains or the single domain.

9. The display unit according to claim 8, wherein
each of the unit pixels includes a plurality of domains, and
each of the domains is configured as a one successive region.

10. The display unit according to claim 9, wherein
the liquid crystal display section includes
a first alignment film disposed between the second liquid crystal layer and the third electrodes, and including a plurality of first alignment regions determining the liquid crystal alignment, and
a second alignment film disposed between the second liquid crystal layer and the fourth electrode, and including a plurality of second alignment regions determining the liquid crystal alignment,
the domains are regions determined by the first alignment regions and the second alignment regions, and
the second structures are the third electrodes.

11. The display unit according to claim 10, wherein
the first alignment film includes two first alignment regions in a region corresponding to each of the unit pixels, the two first alignment regions being arranged side by side,
the second alignment film includes two second alignment regions in a region corresponding to each of the unit pixels, the two second alignment regions being arranged side by side in a direction intersecting with a direction in which the two first alignment regions are arranged side by side, and
each of the unit pixels includes four domains.

12. The display unit according to claim 9, wherein
the liquid crystal display section includes a fifth electrode disposed between the third electrodes and the second liquid crystal layer,
the fifth electrode includes a plurality of branch regions, each of the branch regions including second branch portions extending in a same direction,
the domains are regions corresponding to the branch regions, and
the second structures are the second branch portions.

13. The display unit according to claim 12, wherein
the fifth electrode further includes
a second trunk portion, and
a third trunk portion intersecting with the second trunk portion,
the branch regions are four regions separated by the second trunk portion and the third trunk portion, and
the branch portions in the respective branch regions extend from the second trunk portion and the third trunk portion in a direction differing between the branch regions.

14. The display unit according to claim 9, wherein
each of the third electrodes includes one or two third slits,
the fourth electrode includes one or two fourth slits in a region corresponding to each of the unit pixels, the one or two fourth slits being formed in portions different from the one or two third slits, and
the domains are regions determined by the one or two third silts and the one or two fourth slits.

15. The display unit according to claim 14, wherein
each of the third electrodes includes one third slit, and
the fourth electrode includes one fourth slit in each of two sub-regions formed through separating a region corresponding to each of the unit pixels by the third slit.

16. The display unit according to claim 9, wherein
the fourth electrode includes holes in portions corresponding to the unit pixels, and
the domains are regions arranged around each of the holes.

17. The display unit according to claim 8, wherein
each of the unit pixels includes a single domain,
the liquid crystal layer is made of a TN liquid crystal, and
the domain is a region corresponding to each of the unit pixels.

18. The display unit according to claim 9, wherein
each of the unit pixels includes a plurality of domains, and
areas of the domains are substantially equal to one another.

19. The display unit according to claim 8, wherein
the liquid crystal display section includes a plurality of pixels,
each of the pixels includes a plurality of sub-pixels, and
each of the sub-pixels includes a plurality of the unit pixels.

20. The display unit according to claim 8, wherein
the liquid crystal display section includes a plurality of pixels,
each of the pixels includes a plurality of sub-pixels, and
the sub-pixels are the unit pixels.

21. An electronic apparatus provided with a display unit and a control section which performs operation control with use of the display unit, the display unit comprising:
a light-ray control section including first structures, the first structures being arranged at a first pitch;
a liquid crystal display section including second structures, the second structures being arranged at a second pitch; and
a backlight,
wherein one in which a structure arrangement pitch is smaller of the liquid crystal display section and the light-ray control section is disposed between the other one of the liquid crystal display section and the light-ray control section, and the backlight.
